(19) United States
(12) Patent Application Publication
(10) Pub. No.: US 2024/0383615 A1
(43) Pub. Date: Nov. 21, 2024

(54) PACKAGE ACCEPTANCE SYSTEM OF AN UNMANNED VEHICLE PICK-UP AND DELIVERY SYSTEM AND METHODS OF USE

(71) Applicant: DroneUp, LLC, Virginia Beach, VA (US)

(72) Inventor: Perry Q. ANDERSON, Kensington, CA (US)

(21) Appl. No.: 18/401,039

(22) Filed: Dec. 29, 2023

Related U.S. Application Data
(60) Provisional application No. 63/539,074, filed on Sep. 18, 2023.
(60) Provisional application No. 63/467,854, filed on May 19, 2023.

(51) Int. Cl. B64F 1/32; B64U 70/90; B64U 101/64

(52) U.S. Cl. CPC B64F 1/32; B64U 70/90; B64U 2101/64

(57) ABSTRACT

Embodiments of a package acceptance system, and methods of its use, are described. An apparatus includes a container at least partially disposed in a package repository having access to an unmanned vehicle portal. The container defines a chamber configured to receive a package from a user. The apparatus includes a first actuatable wall portion movably coupled to a first side of the container and configured to move in a first direction into the chamber when the first actuatable wall portion is actuated. The apparatus includes a second actuatable wall portion movably coupled to a second side of the container and configured to move in a second, different, direction into the chamber when the second actuatable wall portion is actuated. The first and second actuatable wall portions are collectively configured to move the package received in the chamber into a predetermined position.

### CROSS-REFERENCE TO RELATED APPLICATIONS

This application claims priority to and the benefit of U.S. provisional patent application No. 63/539,074, filed Sep. 18, 2023, titled “SYSTEMS AND METHODS TO STORE AND RETRIEVE PACKAGES FROM A CONTAINER THAT INCLUDES A POLAR AXIAL ROBOT,” and U.S. provisional patent application No. 63/467,854, filed May 19, 2023, titled “SYSTEMS AND METHODS TO STORE AND RETRIEVE PACKAGES FROM A CONTAINER THAT INCLUDES A POLAR AXIAL ROBOT,” the contents of each of which are incorporated by reference herein in its entirety.

This application is related to U.S. non-provisional patent application No. [Attorney Docket No.: DRUP-008/00US 334412-2030], filed concurrently herewith, U.S. non-provisional patent application No. [Attorney Docket No.: DRUP-009/00US 334412-2033], filed concurrently herewith, U.S. non-provisional patent application No. [Attorney Docket No.: DRUP-011/00US 334412-2032], filed concurrently herewith, U.S. non-provisional patent application No. [Attorney Docket No.: DRUP-012/00US 334412-2031], filed concurrently herewith, and U.S. provisional patent application No. 63/539,059, filed Sep. 18, 2023, the contents of each of which are incorporated by reference herein in its entirety.

### FIELD

One or more embodiments are related to systems and methods to store and retrieve packages from a container that includes a polar axial robot.

### BACKGROUND

Drones can sometimes be used to deliver packages. As such, it can be desirable in at least some situations to have a system that can accept packages from and/or provide packages to a drone.

### SUMMARY

Embodiments of a package acceptance system, and methods of its use, are described. In an embodiment, an apparatus includes a container that is at least partially disposed in a package repository having access to an unmanned vehicle portal. The container defines a chamber configured to receive a package therein from a user. The apparatus also includes a first actuatable wall portion movably coupled to a first side of the container. The first actuatable wall portion is configured to move in a first direction into the chamber when the first actuatable wall portion is actuated. The apparatus also includes a second actuatable wall portion movably coupled to a second side of the container. The second actuatable wall portion is configured to move in a second direction, different from the first direction, into the chamber when the second actuatable wall portion is actuated. The first actuatable wall portion and the second actuatable wall portion are collectively configured to move, when the first actuatable wall portion is moved in the first direction and the second actuatable wall portion is moved in the second direction, the package received in the chamber into a predetermined position with respect to the container.

### BRIEF DESCRIPTION OF THE DRAWINGS

FIG. 1 shows a perspective view of an interior of a container, according to an embodiment.

FIG. 2 show a perspective view of a portion of the container of FIG. 1.

FIG. 3 shows a perspective view of a portion of a polar-axial robot, according to an embodiment.

FIG. 4 shows a perspective view of a package being lifted from a shelf of an elevator, according to an embodiment.

FIGS. 5A-5D show images illustrating steps for picking up a package, according to an embodiment.

FIGS. 5E-5G show images illustrating steps for extending a portion of the polar-axial robot of FIG. 3, according to an embodiment.

FIG. 6A shows a perspective view of a package acceptance system (PAS) coupled to a container, according to an embodiment.

FIG. 6B shows a perspective view of the PAS of FIG. 6A, with the container removed.

FIG. 6C shows a schematic diagram of a PAS with load cells to determine a weight and/or center of gravity of a package, according to an embodiment.

FIGS. 7A-7C show a door and cover in an open position, closed position, and position between the open and closed position, according to an embodiment.

FIG. 8 shows perspective view of a landing pad access door, according to an embodiment.

FIGS. 9A-9B shows a landing pad access door in a closed position and an open position, according to an embodiment.

FIG. 10 shows an alignment system, according to an embodiment.

FIG. 11 shows a perspective view of an exterior of a container, according to an embodiment.

### DETAILED DESCRIPTION

Some implementations herein are related to receiving packages from unmanned vehicles and/or users, managing those packages, and providing packages to unmanned vehicles and/or users. In one example, an unmanned vehicle refers to an autonomous vehicle. In another example, an unmanned vehicle refers to a vehicle that can be remotely piloted. Although the below description will mostly be discussed in the context of drones, it can be appreciated that the unmanned vehicle can be any other type of vehicle, such as an aerial vehicle different than a drone, a ground vehicle, a water vehicle, and/or the like.

### Drone Pick-Up and Delivery System

Some implementations are related to a drone pick-up and delivery system configured for automatic robotic internal package transfer. The system can store packages, receive packages from and/or provide packages to a drone via an unmanned vehicle portal (e.g., drone landing pad), and receive packages from and/or provide packages to a user via a customer access portal. Said differently, a package can be automatically transferred from an unmanned vehicle portal of the container through an internal chamber of the container to a customer access portal, and vice versa, and in some implementations the package can be stored within, outside, or near (e.g., within one meter of, within five meters of, within ten meters of, within 25 meters of, etc.) the container before the package is retrieved by a drone or user (e.g., customer such as a package sender or a package recipient).

In some implementations, multiple packages can be handled and transferred by the drone pick-up and delivery system in concurrent processes (e.g., packages can be transferred to or from a drone while a customer is dropping off or picking up a package via the container, which helps ensure neither the customer nor the drone is delayed due to the interaction of the other with the container).

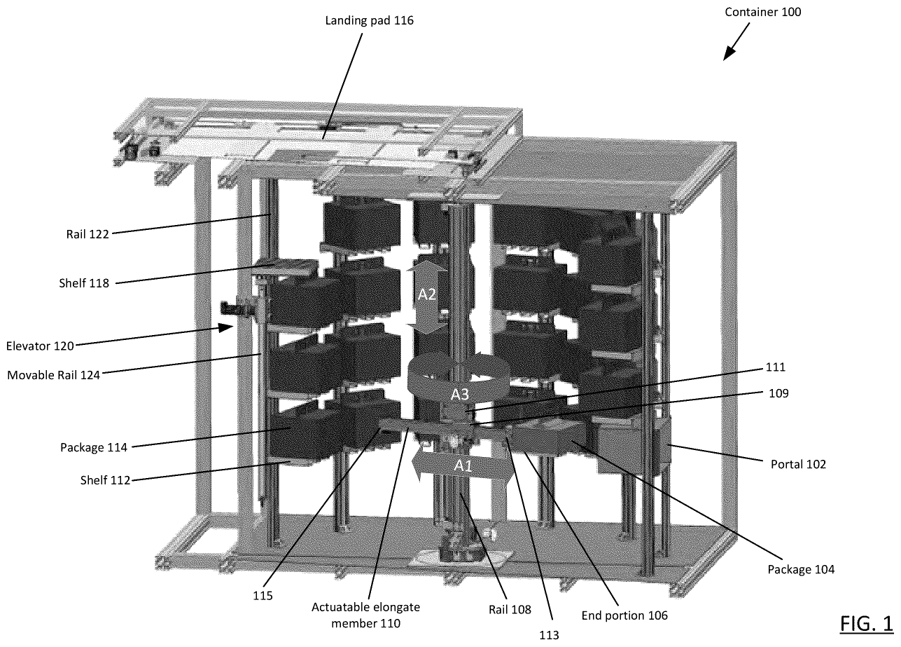

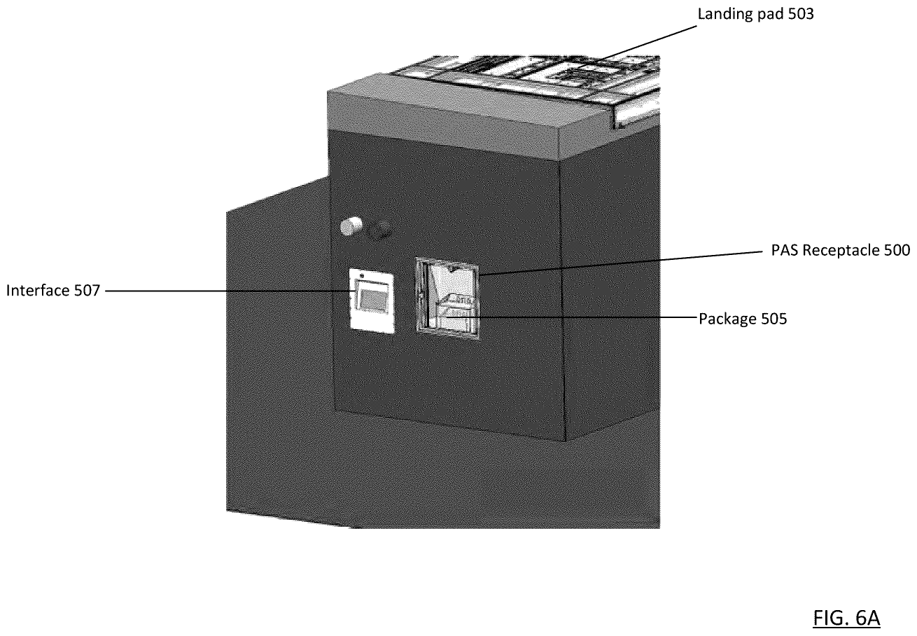

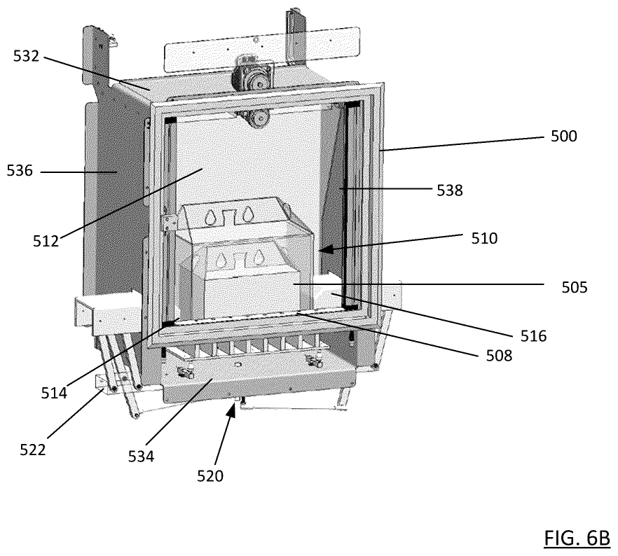

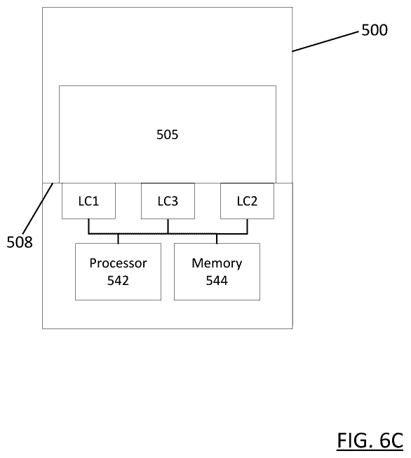

FIG. 1 shows a perspective view of an interior of a container 100, according to an embodiment. The container 100 includes portal 102 configured to permit a package to be conveyed therethrough from outside of the container 100 to the interior of the container. In some implementations, the portal 102 (sometimes also referred as an “access portal” or “customer access portal”) can be used by users (e.g., customers) to put packages into container 100 and/or retrieve packages from container 100. In some implementations, portal 102 is within container 100, and has an opening (e.g., door) on at least one side for packages to be placed. Additional details related to portals as discussed herein (e.g., with respect to FIGS. 6A-6B). In some embodiments, the portal can be used for a package to move between an unmanned vehicle portal 116 and the interior of the container, as discussed herein.

Within the container 100, a rail 108 and an actuatable elongate member 110 can be included in a polar-axial robot configured to move packages, such as package 104 and/or package 114, to and/or from a portal 102, a shelf (e.g., a shelf 118 of elevator 120 operatively coupled to an unmanned vehicle portal 116), or a package repository within container 100 (e.g., a shelf 112 disposed within the package repository). In some implementations, the package repository can be used to store a package that is not yet to be given to a drone or user. The package repository can include the shelf 112, which is shown in FIG. 1 as having the package 114 disposed thereon. The package repository of the container 100 can include multiple shelves, enabling the package repository to hold or store multiple packages. In some implementations, packages within the container 100, or the package repository of the container, are not accessible from outside of the container 100, such by from a user or drone. More particularly, the container 100 can be configured such that the package repository, or the shelf 112, is not accessible from outside of the container. In some implementations, the interior of the container 100 resembles a room and includes the shelves (e.g., shelf 112) and packages (e.g., package 114). In some implementations, the container 100 has a door that allows a user to enter into the interior of the container 100 (e.g., by unlocking the door) and accessing the inside of the container 100 (e.g., to rearrange packages, to perform maintenance work, etc.). In some implementations, packages within container 100 are not accessible from outside the container 100, other than via the portal 102, unless a user (e.g., a maintenance person) unlocks and opens the door to get into the room of the container 100.

Rail 108, actuatable elongate member 110, and one or more actuators operatively coupled to rail 108 and/or actuatable elongate member 110 can be part of a polar-axial robot that can be used to move an end portion 106 of the actuatable elongate member 110 along three dimensions: rotate about a vertical axis (e.g., rotate around rail 108, in the general direction of arrow A3), move vertically along on the vertical axis (e.g., move up and down along rail 108, in the general direction of arrow A2), and extend or retract towards or away from the vertical axis (e.g., move closer to or further from rail 108, in the general direction of arrow A1). The polar-axial robot can be configured to move along any of the three dimensions in any sequential order, in parallel, or a combination thereof. For example, the polar-axial robot can be configured to rotate via rail 108 first, move along the vertical axis via actuatable elongate member 110 second, then extend or retract via actuatable elongate member 110 third. As another example, the polar-axial robot can be configured to extend or retract via actuatable elongate member 110 first, then concurrently rotate via rail 108 and move along the vertical axis via actuatable elongate member 110 second.

In some implementations, rail 108 has a rotational range of motion (e.g., 180 degrees, 270 degrees, 360 degrees, etc.). Said differently, rail 108 is able to rotate. In some implementations, rail 108 does not have a rotational range of motion. Said differently, rail 108 does not rotate.

The actuatable elongate member 110 can be coupled to the rail 108 in any suitable manner that permits movement of the actuatable elongate member 110, and thus also end portion 106, substantially along a first dimension between a retracted position and an extended position relative to the rail 108 and substantially along a second dimension (e.g., vertically along the vertical axis) that is different from the first dimension and that includes a first position and a second position.

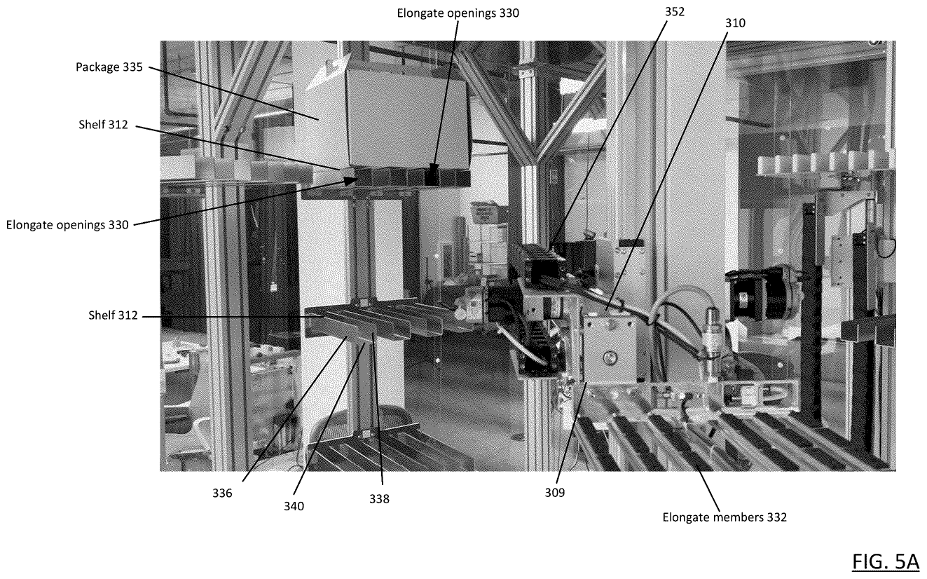

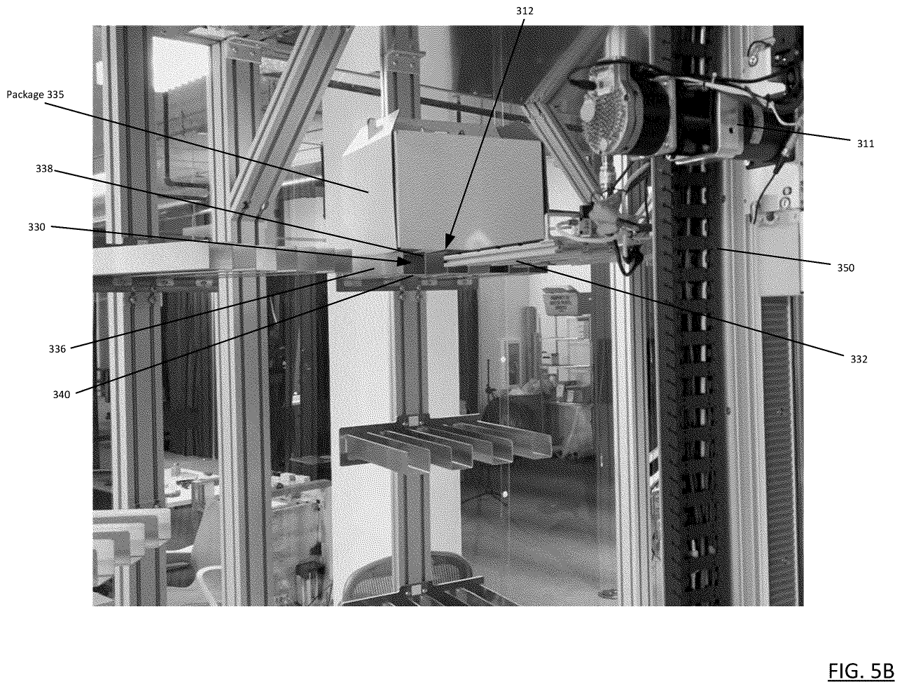

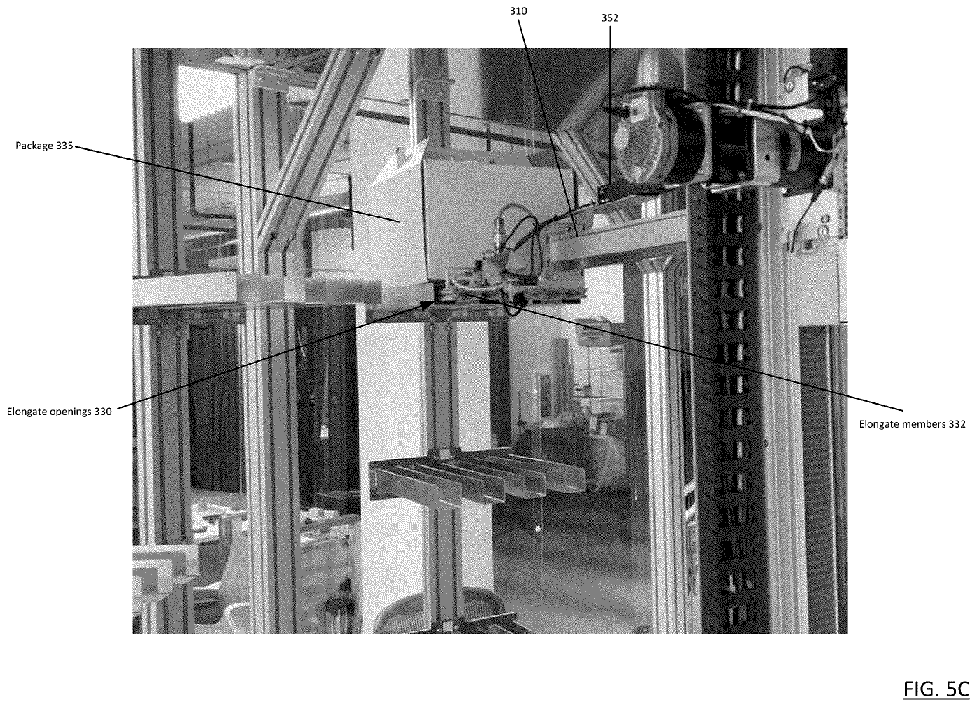

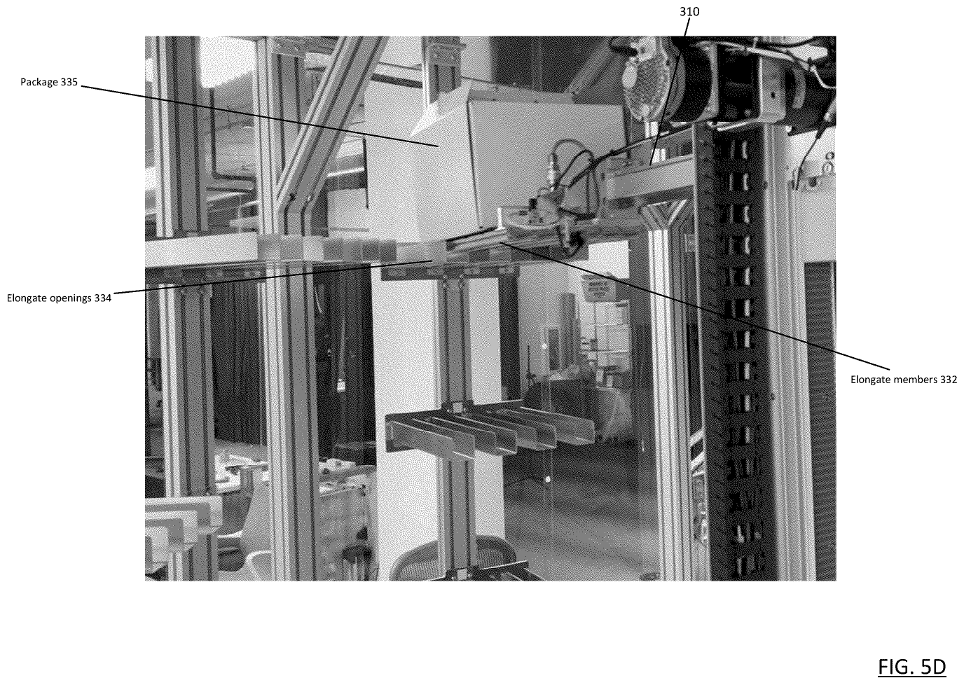

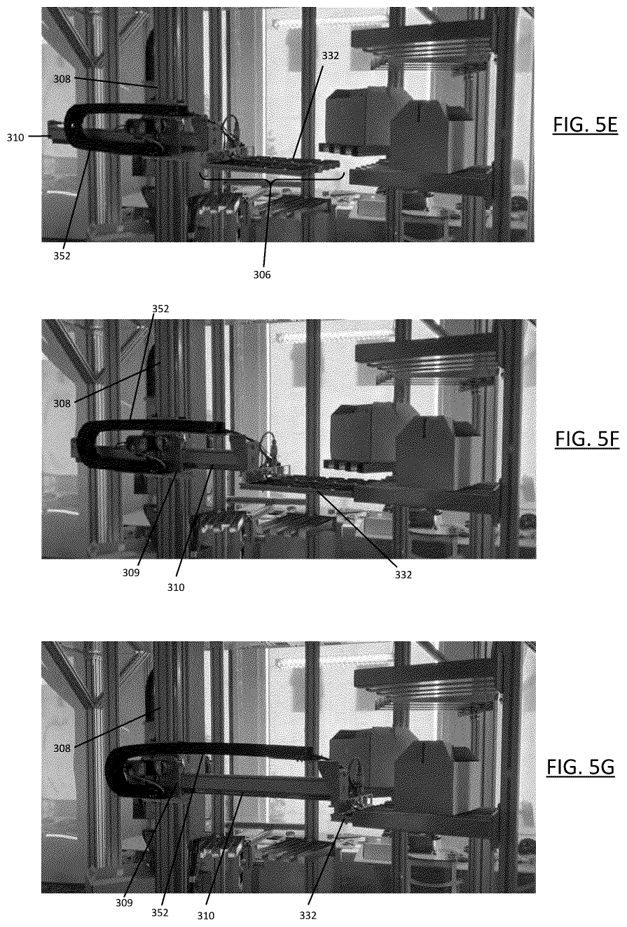

For example, as shown in FIG. 1, the actuatable elongate member 110 can be coupled to the rail 108 by a joint 109 (e.g., a translational joint, a linear joint, or the like) that permits the actuatable elongate member 110 to move from the retracted position to the extended position, and from the extended position to the retracted position (in the direction of arrow A1). Similarly, the actuatable elongate member 110 can be coupled to the rail 108 by another (or second) joint 111 (e.g., a translational joint, a linear joint, or the like) that permits the actuatable elongate member 110 to move along the vertical axis from the first position to the second position and/or from the second position to the first position (e.g., along the second dimension, in the direction of arrow A2). Additional details related to a suitable translational joint is described in more detail herein (e.g., with respect to FIGS. 5A-5G).

The translational joint can be defined as allowing one part (e.g., the actuatable elongate member 110) to translate along a vector (e.g., the first dimension or the second dimension, described herein) in respect of another part (e.g., the rail 108). More specifically, the translational joint permits at least one of the part to translate, but not rotate (at least at that particular joint), with respect to the other part. The translational joint can be characterized as having one translational degree of freedom, but no rotational degree of freedom (i.e., the rotational degree of freedom is zero). In some implementations, the translational joint permits the part being translated (e.g., the actuatable elongate member 110) to move through the joint (e.g., a housing, bracket, or the like, of the joint) during translation. A linear joint can be defined as allowing adjacent parts to have relative motion that is parallel (or substantially parallel) or coincident (or substantially coincident). More specifically, in a linear joint, an input part and an output part can slide in a linear motion, resulting in a translational motion (e.g., of the actuatable elongate member 110). Such linear motion can be achieved in several ways, including, but not limited to, the use of a telescoping mechanism and a piston.

In some implementations, actuatable elongate member 110 moves vertically along rail 108 (e.g., via an actuator operatively coupled to rail 108 and/or actuatable elongate member 110). In some implementations (e.g., where rail 108 does not have a rotational range of motion), actuatable elongate member 110 is configured to rotate around rail 108. In some implementations (e.g., where rail 108 does have a rotational range of motion), actuatable elongate member 110 is not configured to rotate around rail 108.

Actuatable elongate member 110 can also extend and retract (e.g., by sliding in one direction or the opposite direction, by telescoping in or out, by folding or unfolding, etc.) such that end portion 106, which is operatively coupled to an end (e.g., distal end) 113 of actuatable elongate member 110, can move closer to and/or further from rail 108. In some implementations, a second, opposing (e.g., proximal) end 115 of the actuatable elongate member 110 moves closer to the rail 108 when the end portion 106 moves along the first dimension further away from the rail 108, during extension of the actuatable elongate member 110. Similarly, the second or proximal end 115 of the actuatable elongate member 110 can move along the first dimension further from the rail 108 when the distal end 113 (and end portion 106) moves along the first dimension closer to the rail 108, during retraction of the actuatable elongate member 110. The first or distal end 113 and end portion 106 of the actuatable elongate member 110 can be disposed to a first side of the rail 108 during the range of motion from retracted to extended and vice versa, and the second or proximal end 115 of the actuatable elongate member 110 can be disposed to a second side of the rail 108, opposite the first side, during the range of motion.

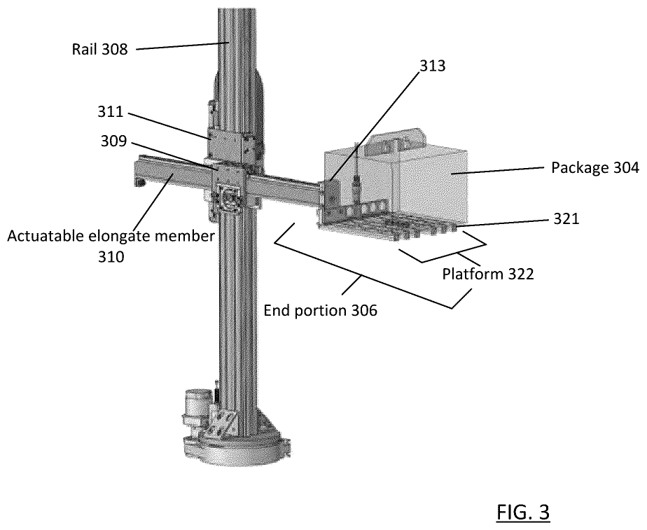

End portion 106 of actuatable elongate member 110 can be configured to hold packages, such as package 104. In some implementations, end portion 106 includes elongate members (e.g., that are not actuatable), where each elongate member is separated by a non-zero distance from an adjacent elongate member(s). The elongate members of end portion 106 can be spaced such that packages can be placed on top of the elongate members, and the elongate members can slide, when actuatable elongate member 110 extends, into elongate openings making up the shelves in container 100 to hold packages. Additional details related to end portions and shelves are discussed later herein (see, e.g., discussion with respect to FIGS. 3, 4, and 5A-5D).

Although FIG. 1 only shows one actuatable elongate member 110 at rail 108, in some implementations, additional actuatable elongate members (e.g., two, three, four, etc.) can be coupled to rail 108. The additional actuatable elongate members can each include an end portion to hold a package, and can be configured to move with respect to rail 108 to place packages on shelves; that way, multiple packages can be moved concurrently or simultaneously within the container. In some implementations, where there are multiple actuatable elongate members at rail 108, rail 108 does rotate around arrow A3. In some implementations, each of the actuatable elongate members can move vertically with respect to a predetermined range (or length) of rail 108; for example, a first actuatable elongate member can travel vertically along substantially the bottom half of rail 108 and a second actuatable elongate member can travel vertically along substantially the top half of rail 108. In some implementations, where there are multiple actuatable elongate members at rail 108, rail 108 does not rotate around arrow A3; rather, each of the actuatable elongate members can be configured to rotate around rail 108 in the direction of arrow A3 and also move vertically with respect to at least a predetermined range (or length) of the rail 108.

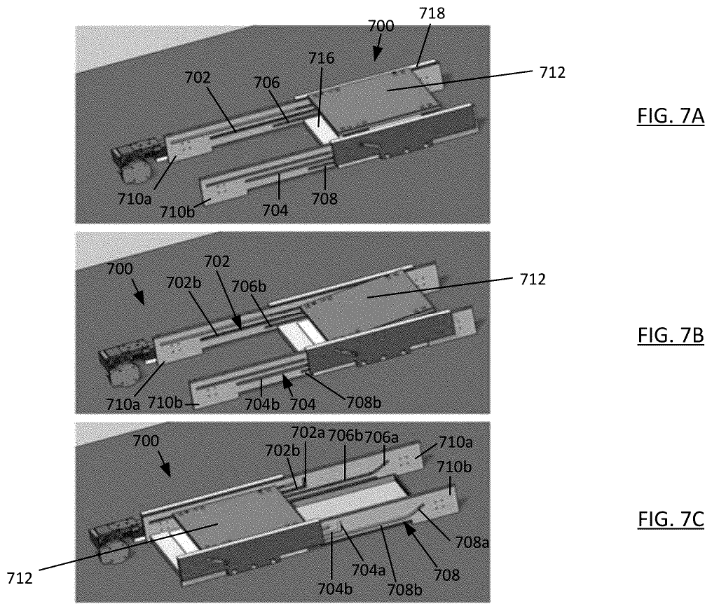

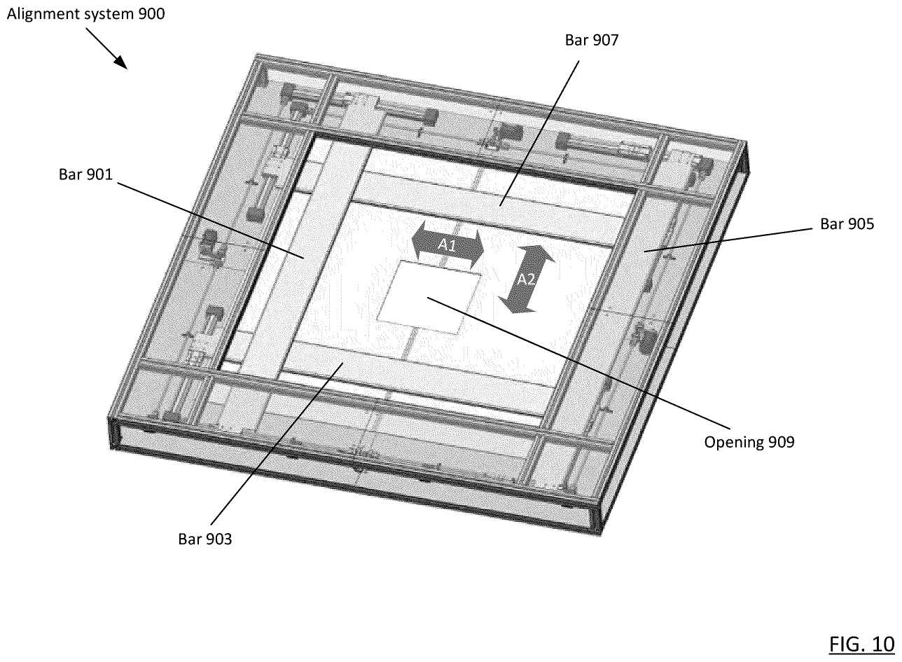

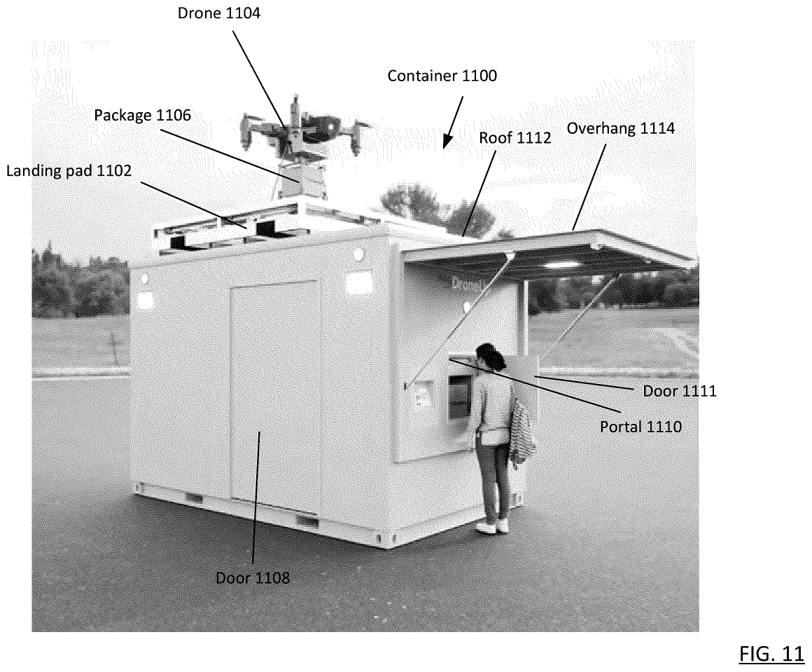

Container 100 also includes landing pad 116. Landing pad 116 can be anywhere on or near container 100. For example, in some implementations, landing pad 116 is located above and/or on an upper surface of container 100. As another example, though not shown in FIG. 1, a platform can protrude from an exterior portion of container 100 for hold landing pad 116. Landing pad 116 can be used by drones to pick up and drop off packages. In some implementations, a landing pad access door can be used at landing pad 116 so that packages can be placed in and/or taken out of container Additional details related to landing pad access doors are discussed later herein (see, e.g., discussion with respect to FIGS. 7A-7C, 8, and 9A-9B). In some implementations, an alignment system can be used at landing pad 116 so that packages can be positioned (disposed) at predetermined locations on landing pad 116 for after drop-off by a drone and/or prior to pick up by a drone. Additional details related to alignment systems are discussed later herein (see, e.g., discussion with respect to FIG. 10).

In some implementations, elevator 120 can be located in the container 100. Elevator 120 can include a shelf 118 and an actuator(s) to move shelf 118 with respect to a rail 122, for example, along a substantially vertical range of motion and/or along a substantially horizontal range of motion. In this manner, the shelf 118 can move (e.g., vertically upwards) with respect to the rail 122 to receive a package from landing pad 116 and can move (e.g., vertically downwards) to move the package into container 100, such as for subsequent retrieval by the polar-axial robot and/or receive packages from the polar-axial robot and bring them to landing pad 116 for subsequent retrieval by a drone. Shelf 118 can be moved vertically upwards by elevator 120 so that the maximum height the upper surface of shelf 118 can reach is (1) substantially level with the upper surface of landing pad 116, (2) above the upper surface of landing pad 116, or (3) below the upper surface of landing pad 116. For example, in some implementations, shelf 118 can move vertically upwards up to and not beyond the point where the upper surface of shelf 118 is substantially level with the upper surface of landing pad 116 (e.g., while a package is being picked up or dropped off by a drone). As another example, in some implementation, shelf 118 can move vertically upwards to a point where the upper surface of shelf 118 is above the upper surface of landing pad 116 (e.g., while a package is being picked up or dropped off by a drone). As another example, in some implementations, shelf 118 cannot move vertically upwards to a point where the upper surface of shelf 118 goes above or is substantially level with the upper surface of landing pad 116 (e.g., while a package is being picked up or dropped off by a drone), In some implementations, the shelf 118 of the elevator 120 is coupled to a vertically movable rail 124. The vertically movable rail 124 is coupled to and movable with respect to rail 122, for example, along a substantially vertical range of motion. The rail 122 can be a fixed rail. The elevator 120 shown in FIG. 1 does not include an at least partially enclosed shaft through which the shelf 118 is moved through at least a portion of its range of motion within the interior of the container during movement of the elevator 120 through at least a portion of its range of motion within the interior of the container. In some implementations, however, the elevator 120 can have an at least partially enclosed shaft (e.g., defined by one or more walls). Although rail 122 is substantially vertical in FIG. 1, in other implementations, rail 122 can be any shape and have any orientation. In some implementations, shelf 118 has a centerpoint substantially coaxial with a centerpoint of the opening of landing pad 116.

In some implementations, the elevator 120 (and shelf 118) can operate independent of the polar-axial robot such that elevator can raise or lower a package using shelf 118 with respect to landing pad 116 (e.g., to unload or load a drone, respectively) while the polar-axial robot moves a different package within container 100, such as to or from an internal shelf in container 100 for storage, portal 102, or the elevator. In some implementations, elevator 120 is omitted from container 100. In some implementations, elevator 120 can operate in combination with the polar-axial robot so that only a single package is transferred within container 100 at a given moment. For example, where elevator 120 is omitted from container 100, the polar-axial robot can transfer package 104 directly to landing pad 116. For example, the end portion 106 of actuatable elongate member 110 can be radially positioned with respect to the rail 108 such that a package disposed on the end portion 106 of the actuatable elongate member 110 is substantially aligned with and then passed through a portal to the landing pad 116 when the actuatable elongate member 110 reaches a predetermined height along a range of motion with respect to the rail 108 (described in more detail herein). In such as case, the end portion 106 can be moved vertically upwards so that the maximum height that the upper surface of the end portion 106 can reach is (1) substantially level with the upper surface of landing pad 116, (2) above the upper surface of landing pad 116, or (3) below the upper surface of landing pad 116. As another example, where elevator 120 operates in combination with the polar-axial robot, elevator 120 can be configured to not move when the polar-axial robot is moving, and conversely the polar-axial robot can be configured to not move when elevator 120 is moving.

Container 100 can include multiple shelves (e.g., 20, 25, 30, 50, 100, etc.) for holding packages after being received from a drone via landing pad 116 and/or a user via portal 102. In some implementations, each shelf includes multiple vertical posts to which platforms are coupled.

The shelves can be at any location in container 100. For example, the shelves can be cylindrically arranged and/or vertically arranged along multiple levels. In some implementations, the front of each shelf faces rail 108 of the polar-axial robot. Any number of shelves can be used, such as 20, 25, 30, 50, 100, 1000, and/or the like. For example, if 20 shelves are used, the shelves can be arranged within container 100 in four vertical rows and five cylindrically-arranged columns. As another example, if 30 shelves are used, the shelves can be arranged within container 100 in five vertical rows and five cylindrically-arranged columns. As yet another example, if 36 shelves are used, the shelves can be arranged within container 100 in four vertical rows and nine cylindrically-arranged columns. Any number of row and columns, however, can be used to store any number of shelves. The columns can be, but do not need to be, equidistantly spaced around rail 108. In some implementations, the shelves can be equidistantly spaced around rail 108 except that two adjacent columns of shelves have a larger space therebetween than the equidistant spacing between the other columns of shelves; in this manner, there can be space between two adjacent columns such that a person can pass through the space to access rail 108 (e.g., for maintenance). In some implementations, the vertical position of each shelf is fixed (i.e., is not automatically adjustable).

In some implementations, each shelf in container 100 is of the same size, of a different size, or a combination of some shelves that are the same size and some that are different size. The shelves in container 100 acting as a package repository can be all substantially the same distance from rail 108, all substantially not the same distance from rail 108, or have a combination of shelves that are substantially the same distance from rail 108 and not substantially the same distance from rail 108. In some implementations, the shelves acting as package repositories can be disposed in a cylindrical pattern, arc pattern, and/or the like.

In one example use case scenario, a drone and/or a package carried by the drone lands on landing pad 116. Thereafter, the package enters container 100 via shelf 118 of elevator 120. The polar-axial robot of container 100 can then obtain the package and place the package in an internal shelf/platform (i.e., package repository), such as shelf 112, or put the package in portal 102.

In another example, a customer places a package in portal 102. The polar-axial robot can hold the package at the end portion 106, and place the package in a package repository inside container 100, on shelf 118, or in landing pad 116. If, for example, a drone has not yet arrived at container 100 to take the package, the polar-axial robot can place the package in a package repository inside container 100, and retrieve the package from once the drone arrives and/or is a predetermined distance from container 100.

Packages can also be moved within container 100, such as from one shelf of container 100 to a different shelf of container. For example, if there is not an available shelf large enough for a first package (e.g., received by a drone or human), a different second package at a shelf that is large enough to hold the first package can be moved to a different smaller shelf (assuming one is available) so that the first package can be placed on the larger shelf.

In some implementations, packages received from an unmanned vehicle can be placed at a shelf that is closer to portal 102; that way, when a user has come to pick up that package, the distance the package travels from the shelf to portal 102 is relatively lower. Similarly, packages received by a user can be placed at a shelf that is closer to landing pad 116; that way, when an unmanned vehicle comes to pick up that package, the distance the package travels from the shelf to landing pad 116 is relatively lower.

In some implementations, one or more of the aforementioned techniques can be automated (e.g., performed without human interaction) based on signals (e.g., electronic signals) received from a drone, drone operator, input from a customer, reading a tag from a package, and/or the like. For example, in response to receiving an indication (e.g., an electronic signal from the drone) that a drone is within a predetermined distance from container 100 to pick up a certain package, the polar-axial robot can obtain that package from within container 100 and position it on or with respect to the landing pad 116 so that the drone can pick up the package.

Although not explicitly shown in FIG. 1, container 100 includes one or more controllers for controlling the actuator(s) that move the polar-axial robot and elevator 120. In some implementations, a single controller can control all actuators in container 100 to move the polar-axial robot and elevator 120. In some implementations, different controllers can control different actuators in container 100 to ultimately move the polar-axial robot and elevator 120. For example, a first controller can be used to control an actuator(s) for moving the polar-axial robot, and a second controller can be used to control an actuator(s) for moving elevator 120 (where the first and second controllers can operate independently and without communicating with one another in some implementations, and can operate dependently and with communication with one another in some other implementations).

In some implementations, each controller can include a processor and a memory operatively coupled to the processor. The processor can be, for example, a hardware based integrated circuit (IC), or any other suitable processing device configured to run and/or execute a set of instructions or code. For example, the processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor can be configured to run any of the methods and/or portions of methods discussed. The memory can be, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory can include extendable storage units that can be added and used incrementally. In some implementations, the memory can be a portable memory (e.g., a flash drive, a portable hard disk, and/or the like) that can be operatively coupled to the processor. In some instances, a memory can be remotely operatively coupled with a compute device (not shown).

In some implementations, the memory includes a representation of instructions (e.g., code) that can be used to control the polar-axial robot and elevator 120. In some implementations, the instruction can include code to cause, via the processor, one or more actuators to move at one or more times for certain periods of time in one or more sequences to carry out the techniques described herein. For example, the instructions can include code to cause the processor to send a first electronic signal to an actuator(s) that can control the polar-axial robot to pick up a package and place that package on shelf 118, then cause the processor to send a second electronic signal to a different actuator(s) that can control elevator 120 to raise the package 104 to landing pad 116. Additionally, in some implementations, the memory includes information associated with packages, such as which shelf a package is at, when the package was received, the weight of the package, who the package is for, and/or the like.

Although not explicitly shown in FIG. 1, container 100 includes a receiver and/or transceiver to receive (or receive and send) signals (e.g., electronic signals). The receiver and/or transceiver can be communicably coupled to the controller(s). For example, the receiver and/or transceiver can receive a signal from a drone indicating that the drone is arriving or will arrive within a determined amount of time, or that the drone has arrived. In another example, the receiver and/or transceiver can receive a signal from a drone indicating the package that the drone is to pick up, the package that the drone is to drop off, and/or the like. A representation of that signal can then be sent to the controller(s) to control movements within container 100 (e.g., move a package, weight a package, open a door, and/or the like).

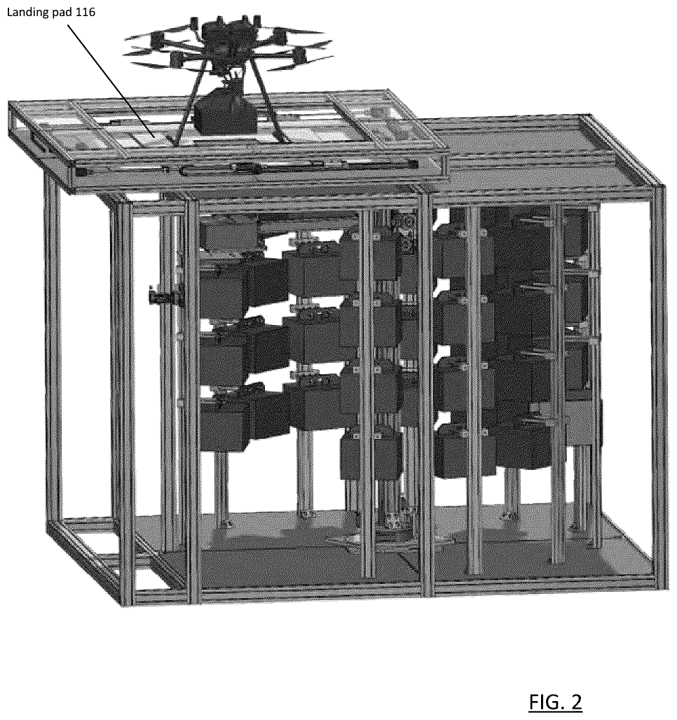

Although FIG. 1 shows packages placed on top of shelves (e.g., package 114 is on top of shelf 112), in some implementations, the packages can be hung within container 100. For example, as shown in FIG. 2, each package is suspended via two elongate members that have been inserted within holes of their respective packages.

Although FIG. 1 shows landing pad 116 on the roof of container 100, in other implementations, landing pad 116 is not on the roof of container 100. For example, landing pad 116 can instead of additionally be located at a shelf exterior to container 100 and below the roof of container 100. In such a case, elevator 120 can be configured to move shelf 118 along multiple axes, such as vertically and horizontally, to retrieve and deliver a package via landing pad 116.

In an embodiment, a drone pick-up and delivery system includes a shelf associated with one of (or at least one of in other implementations) (1) an elevator (e.g., elevator 120) having a range of motion configured to access an unmanned vehicle portal (e.g., landing pad 116), (2) a portal (e.g., portal 102) through which packages can be received and delivered, or (3) a package repository (e.g., including a package repository that holds package 114). The system further includes a rail (e.g., rail 108) that has a rotational range of motion that includes a first position and a second position. The system further includes an actuatable elongate member (e.g., actuatable elongate member 110) coupled to the rail and having a distal end portion (e.g., end portion 106). The actuatable elongate member has a distal end portion fixedly coupled to a distal end of the actuatable elongate member. The actuatable elongate member has a range of motion substantially along a first dimension between a retracted position and an extended position and having a range of motion relative to the rail and substantially along a second dimension that is different from the first dimension and that includes a first position and a second position. The system further includes an actuator configured to automatically cause, in response to a signal (e.g. electronic signal) associated with one of delivery or receipt of a package, (1) the rail to rotate from the first position to the second position, (2) the actuatable elongate member to move relative to the rail substantially along the second dimension from the first position to the second position, and (3) the actuatable elongate member to move substantially along the first dimension from the retracted position to the extended position, to position the distal end portion of the actuatable elongate member for retrieval of the package from the shelf.

In some implementations of the system, the actuator is configured to cause the actuatable elongate member to move substantially along the first dimension only after the actuator has caused the rail to rotate and the actuatable elongate member to move relative to the rail substantially along the second dimension.

In some implementations of the system, the actuatable elongate member has a centerline substantially along the first dimension, and the rail has a centerline substantially along the second dimension.

In some implementations of the system, the signal is associated with receipt of the package, and the shelf is an access shelf (e.g., shelf 118, a shelf, not shown in FIG. 1, included in portal 102 and/or the like) associated with one of (1) the elevator 120 having the range of motion configured to access the unmanned vehicle portal, or (2) the portal 102 through which packages can be received and delivered. The system can further include a plurality of shelves (e.g., including shelf 112) configured to be associated with the package repository. The actuator can be configured to automatically cause, in response to the signal, the rail and the actuatable elongate member, collectively, to transfer the package from the access shelf to one of a first shelf (e.g., shelf 118) from the plurality of shelves, or the other of the elevator or the portal.

In some implementations of the system, the shelf is an access shelf (e.g., shelf 118, a shelf included in portal 102, and/or the like) associated with one of (1) the elevator 120 having the range of motion configured to access the unmanned vehicle portal, or (2) the portal 102 through which packages can be received and delivered. The system can further include a plurality of shelves disposed in one of a cylindrical pattern or an arc pattern at a substantially (e.g., within 1%, within 5%, within 10%, within 25%, within 33%, etc.) common distance from the rail.

In some implementations of the system, the shelf is an access shelf (e.g., shelf 118, included in portal 102, etc.) associated with one of (1) the elevator having the range of motion configured to access the unmanned vehicle portal, or (2) the portal through which packages can be received and delivered. The system can further include a plurality of shelves that includes a first shelf, a second shelf, a third shelf and a fourth shelf. The first shelf and the second shelf are disposed at a first angular position with respect to the rail and a first radial distance from the rail. The first shelf is disposed above the second shelf. The third shelf and the fourth shelf are disposed at a second angular position with respect to the rail and a second radial distance from the rail. The third shelf is disposed above the fourth shelf. The first angular position is different from the second angular position. The first radial distance is substantially equal to the second radial distance.

In some implementations of the system, the actuator is configured to position the distal end portion of the actuatable elongate member beneath an upper surface of the shelf when the distal end portion of the actuatable elongate member is in the extended position so that the distal end portion of the actuatable elongate member is positioned to lift the package from the shelf.

In some implementations of the system, the actuatable elongate member is configured to move substantially along the second dimension substantially concurrently with rotation of the rail. The actuatable elongate member is also configured to move substantially along the first dimension between the retracted position and the extended position substantially non-concurrently with movement of the actuatable elongate member along the second dimension.

In some implementations of the system, the signal includes an indication of delivery of the package and is received from a drone, and the shelf is associated with the package repository. The actuator is configured to further automatically cause (e.g., without human intervention), in response to the signal, the actuatable elongate member to retrieve the package from the shelf and the actuatable elongate member and the rail to collectively transfer the package to one of the elevator or to the unmanned vehicle portal.

In an embodiment, a method includes rotating a rail (e.g., rail 108) from a first position to a second position along a substantially rotational range of motion. The rotating is automatically initiated in response to receipt of a signal (e.g., electronic signal) indicative of one of delivery of a package or receipt of a package (e.g., package 104). The method further includes moving an actuatable elongate member (e.g., actuatable elongate member 110) substantially along a first dimension from a retracted position to an extended position. The actuatable elongate member is coupled to the rail and has a distal end portion (e.g., end portion 106). The moving the actuatable elongate member substantially along the first dimension is automatically (e.g., without human interaction) initiated in response to receipt of the signal. The method further includes moving the actuatable elongate member relative to the rail substantially along a second dimension that is different from the first dimension. The moving the actuatable elongate member substantially along the second dimension is automatically initiated in response to receipt of the signal. The rotating the rail, the moving the actuatable elongate member substantially along the first dimension, and the moving the actuatable elongate member substantially along the second dimension, collectively, position the distal end portion of the actuatable elongate member beneath an upper surface of a shelf (e.g., shelf 118, shelf 112, a shelf in portal 102, and/or the like) associated with one of (1) an elevator having a range of motion configured to access an unmanned vehicle portal (e.g., drone landing pad), (2) a portal through which packages can be received and delivered, or (3) a package repository.

In some implementations of the method, the moving the actuatable elongate member relative to the rail substantially along the second dimension is at a first time period. The method further includes moving, at a second time period subsequent the first time period, the actuatable elongate member relative to the rail substantially along the second dimension from the second position to a third position above the second position. The moving the actuatable elongate member at the second time period is automatically initiated in response to receipt of the signal.

In some implementations of the method, the shelf is a first shelf. The method further includes moving, at a third time period during or after the second time period and automatically in response to receipt of the signal, the actuatable elongate member substantially along the first dimension from the extended position to the retracted position. The method further includes rotating, at a fourth time period during or after the third time period and automatically in response to receipt of the signal, the rail from the second position to one of the first position or a third position different from the first position and the second position. The third position is radially aligned with a second shelf associated with another of (1) the elevator having the range of motion configured to access the unmanned vehicle portal, (2) the portal through which packages can be received and delivered, or (3) the package repository.

In some implementations of the method, the shelf is a first shelf, and the moving the actuatable elongate member to the extended position is at a first time period. The method further includes retrieving the package from the first shelf at a second time period after the first time period and via the distal end portion of the actuatable elongate member. The retrieving is automatically initiated after the moving the actuatable elongate member to the extended position and in response to the signal. The method further includes depositing the package on a second shelf. The second shelf is associated with one of (1) the elevator having the range of motion configured to access the unmanned vehicle portal, or (2) the portal through which packages can be received and delivered. In some implementations, the depositing is at a third time period and includes rotating, automatically in response to receipt of the signal, the rail from the second position to one of the first position or a third position different from the first position and the second position. The method further includes moving, automatically in response to receipt of the signal, the actuatable elongate member substantially along the first dimension from the retracted position to the extended position so that an upper surface of the distal end portion of the actuatable elongate member is disposed above an upper surface of the second shelf.

In some implementations of the method, the shelf is from a plurality of shelves disposed in one of a cylindrical pattern or an arc pattern at a substantially common distance from the rail.

In some implementations of the method, the rotating the rail and the moving the actuatable elongate member relative to the rail substantially along the second dimension are before the moving the actuatable elongate member substantially along the first dimension.

In some implementations of the method, the rotating the rail is concurrent with the moving the actuatable elongate member relative to the rail substantially along the second dimension and non-concurrent with the moving the actuatable elongate member substantially along the first dimension.

In an embodiment, a system includes an elevator (e.g., elevator 120) having a first shelf (e.g., shelf 118) and a range of motion that is configured to access an unmanned vehicle portal (e.g., landing pad 116). The first shelf has a centerpoint substantially coaxial with a centerpoint of the opening of the unmanned vehicle portal. The system further includes a second shelf associated with one of a portal (e.g., portal 102) through which packages can be received and delivered, or a package repository (e.g., shelf 112). The system further includes a rail (e.g., rail 108) disposed substantially vertically and having a rotational range of motion. The system further includes an actuatable elongate member (e.g., actuatable elongate member 110) coupled to the rail and having a distal end portion (e.g., end portion 106). The actuatable elongate member has a distal end portion fixedly coupled to a distal end of the actuatable elongate member. The actuatable elongate member has a range of motion substantially along a first dimension between a retracted position and an extended position and has a range of motion relative to the rail and substantially along a second dimension that is different from the first dimension. The system further includes an actuator configured to automatically cause, in a concurrent process, (1) the elevator to lower from a first position to a second position, and (2) the rail and the actuatable elongate member to cooperatively retrieve a second package from the second shelf and transfer the second package to a third shelf associated with the other of the package repository or the portal through which packages can be received and delivered.

In some implementations of the system, the system further includes a plurality of shelves disposed in one of a cylindrical pattern or an arc pattern at a substantially common distance from the rail. The plurality of shelves includes the first shelf, the second shelf and the third shelf.

In some implementations of the system, the rail is substantially vertical and the actuatable elongate member is substantially linear and disposed substantially perpendicular to the rail.

### Multipronged End Effector of Polar Axial Robot

Some implementations are related to a multipronged end effector of a robotic arm in a drone pick-up and delivery system for internal package transfer. FIG. 3 shows a perspective view of a portion of a polar-axial robot, according to an embodiment. The polar-axial robot includes rail 308 (e.g., which can be similar or identical to rail 108), actuatable elongate member 310 (e.g., which can be similar or identical to actuatable elongate member 110), end portion 306 (e.g., which can be similar or identical to end portion 106) of actuatable elongate member 310, and platform 322.

Rail 308 is operatively coupled to actuatable elongate member 310. Actuatable elongate member 310 is operatively coupled to end portion 306. End portion 306 of actuatable elongate member 310 includes the platform 322, shown with a package 304 disposed thereon in FIG. 3. Rail 308 and actuatable elongate member 310 can be coupled to one or more actuators such that end portion 306 can be moved vertically, move horizontally, and/or rotate with respect to rail 308.

Platform 322 of actuatable elongate member 310 can include a plurality of elongate members. Each elongate member from the plurality of elongate members can be separated by a non-zero distance amount from elongate members from the plurality of elongate members adjacent to that elongate member. Said differently, each elongate member can be separated from adjacent elongate members by a non-zero distance. The elongate members can be spaced evenly apart, non-evenly apart, or a combination thereof. The elongate members can be all be of the same dimension, all be of different dimensions, or include a combination of elongate members that are the same dimension and elongate members that are different dimensions.

FIGS. 3, 4 and 5A-5G show an apparatus according to an embodiment that can include components that are identical or similar in many respects to other apparatus described herein (e.g., in FIGS. 1-2). The apparatus includes a rail 308 (which can be similar or identical to rail 108) and an actuatable elongate member 310 (which can be similar or identical to actuatable elongate member 110) coupled to the rail 308. Accordingly, such components are not described in detail with respect to FIGS. 3, 4 and 5A-5G. As shown in FIG. 3, the actuatable elongate member 310 includes elongate members 321 that are included in platform 322, which is coupled to a distal end 313 of the actuatable elongate member 310. The elongate members 321 each can have an upper surface configured for a bottom side of package 304 (shown in transparency in FIG. 3 for the sake of illustration) to be disposed thereon. The elongate members 321 can resemble a fork shape such that the elongate members 321 are each spaced apart from an adjacent elongate member 321 substantially along a length thereof. Each elongate member 321 in FIG. 3 can be in the shape of a rectangular prism. One or more elongate members 321, however, can be any suitable shape in other implementations. For example, one or more elongate members 321 can be in the shape of a semi-circular prism, cylinder, a triangular prism, a pentagonal prism, and/or the like. In some implementations, the elongate member 321 can be constructed of any suitable material, such as a metal, plastic, wood, and/or the like, or a combination thereof. Although the platform 322 is shown in FIG. 3 as including 6 elongate members, in other implementations, the platform can include fewer (e.g., two, three, four or five) elongate members or more (e.g., seven to twenty, or more) elongate members.

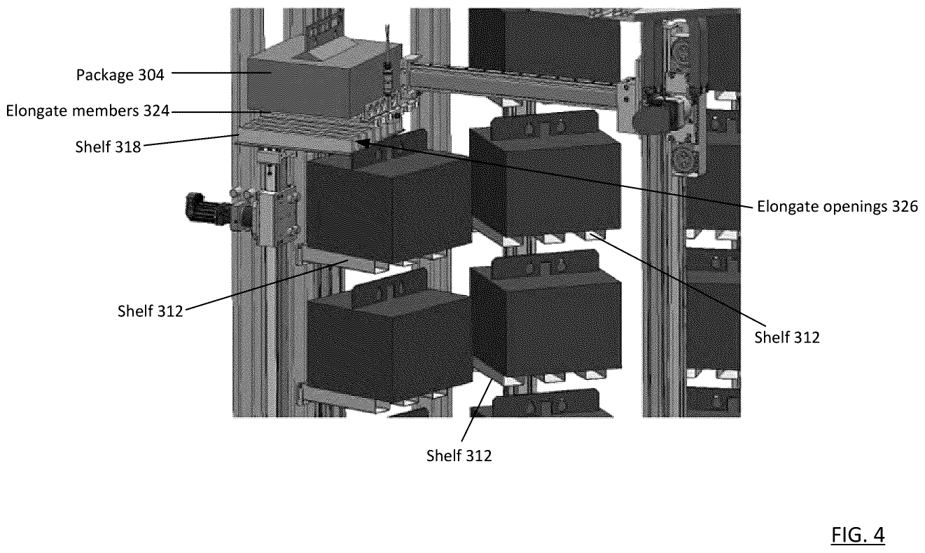

FIG. 4 shows a perspective view of a package being lifted from a shelf of an elevator, according to an embodiment. FIG. 4 shows a shelf 318 (e.g., similar to shelf 118 of elevator 120) that defines elongate openings 326 that make up at least a portion of the shelf. Package 304 can be placed on elongate openings 326 and/or retrieved from elongate openings 326.

As shown in FIG. 4, each elongate opening from elongate openings 326 is defined by three walls: a bottom wall, a first side wall coupled to a first lengthwise end of the bottom wall, and a second side wall coupled to a second lengthwise end of the bottom wall opposite from the first lengthwise end of the bottom wall. The width of each opening from elongate openings 326, as well as the spacing between elongate openings 326, can match/fit elongate members 324 in the sense that a polar-axial robot can, when extended, slide, descend, and/or the like elongate member 324 into elongate openings 326. For example, if picking up package 304 while package 304 is resting on top of the uppermost edges of the side walls for elongate openings 326, elongate members 324 can be (1) extended into elongate openings 326 between the side walls of elongate openings 326, beneath the uppermost ends of the side walls of elongate openings 326, above the bottom wall of elongate openings 326, and beneath the bottom side of package 304, and (2) lifted above the uppermost edges of the side walls for elongate openings 326 to hold (and subsequently move) package 304. As another example, if dropping off package 304 while package 304 is resting on top of elongate members 324, elongate members 324 can be (1) extended into and/or descended into elongate openings 326 between the side walls of elongate openings 326, beneath the uppermost edges of the side walls of elongate openings 326, above the bottom wall of elongate openings 326, and beneath the bottom side of package 304 so that package 304 is resting on elongate openings 326, and (2) retract elongate members 324 so that elongate members 324 are no longer within elongate openings 326 and so that package 304 remains on top of the side walls for elongate openings 326.

A subset of shelves and/or every shelf in a container (e.g., container 100), such as shelves for elevators, shelves for portals, and/or shelves for package repositories, can include an elongate opening 326. In some implementations, each shelf has the same number of elongate openings. In some implementations, some shelves have a different number of elongate openings. In some implementations, the elongate openings of each shelf have the same spacing between elongate members and width for elongate members.

FIGS. 5A-5G show images illustrating steps for picking up a package, according to an embodiment. At FIG. 5A, a package 335 is disposed on a shelf 312 that includes one or more elongate openings 330. Each elongate opening from elongate openings 330 is defined by side walls 336, 338 and a bottom wall 340 and is open at the top. As shown in FIGS. 5A and 5B, the package 335 can be disposed on top of the uppermost edges of the side walls 336, 338 of elongate openings 330. The rail 308 is rotated to radially align the elongate members 332 of the actuatable elongate member 310 with respect to the elongate openings 330 of shelf 312. The actuatable elongate member 310 can also be moved (whether sequentially, concurrently or in an overlapping process) vertically along a second dimension such that the elongate members 332 are at a height that aligns with a height of the elongate openings 330. The actuatable elongate member 310 can be coupled to the rail 308 by a joint 311 (see, e.g., FIG. 5B) that permits movement of the actuatable elongate member 310 with respect to the rail 308 along the second dimension.

The apparatus can include a track 350 (see, e.g., FIG. 5B) with multiple openings arranged on the track and drive gear (or sprocket or the like) (not shown in FIGS. 5A-5G) that is movably engaged with the track (e.g., via a toothed portion of the drive sprocket being received in an opening or recess of the track). As such, the track and drive gear are configured to facilitate vertical movement of the actuatable elongate member 310 with respect to the rail 308. The track 350 can be coupled (e.g., fixedly) at a first location of the track to the joint 311 that is coupled to the actuatable elongate member 310, and coupled (e.g., fixedly) at a second location of the track to the rail 308. The track 350 can be non-continuous, and the first location of the track can at a first end portion of the track and the second location of the track can be at second, opposing, end portion of the track. During operation, the drive gear (sprocket or the like) rotates and engages with the track 350, when operably powered by a power supply (not shown), between the first location and the second location, to move the track 350 over the drive gear thereby moving the actuatable elongate member 310 in a first direction (upwards vertically) or a second direction (downwards vertically) with respect to the rail 308.

At FIG. 5B, elongate members 332, with the actuatable elongate member 310 (hidden from view by the rail 308 in FIG. 5B, but shown in FIGS. 5A, 5C and 5D) in retracted position, are aligned with elongate openings 330. At FIG. 5C, the actuatable elongate member is extended (e.g., along the first dimension) such that elongate members 332 are at least partially disposed within elongate openings 330. In this manner, the elongate members 332 of the actuatable elongate member 310 are disposed beneath the package 335. The actuatable elongate member 310 can be coupled to the rail 308 by a joint 309 (see, e.g., FIG. 5A) that permits movement of the actuatable elongate member 310 towards extension and retraction with respect to the rail 308 along the first dimension. The joint 309 can be, for example, a translational joint.

The apparatus can include a track 352 (see, e.g., FIGS. 5B and 5E-5G) with multiple openings arranged on the track and a drive gear (or drive sprocket or the like) (not shown in FIGS. 5A-5G) coupled to the polar-axial robot that is movably engaged with the track (e.g., via a toothed portion of the drive sprocket being received in an opening or recess of the track). As such, the track and dive gear are configured to facilitate extension and/or retraction of the actuatable elongate member 310. The track 352 can be coupled at a first location of the track to the joint 309 that is coupled to the actuatable elongate member 310, and at a second location of the track to a distal end (and/or the end portion 306) of the actuatable elongate member 310. The track 352 can be non-continuous, and the first location of the track can be at a first end portion of the track (which can be fixedly coupled to the joint 309) and the second location of the track can be at second, opposing, end portion of the track (which can be fixedly coupled to the distal end of the actuatable elongate member 310 and/or end portion 306, shown in FIG. 5E). During operation, the drive gear (sprocket or the like), when operably powered by a power supply (not shown), rotates and engages with the track 352 between the first location and the second location to move the track 352 over the drive gear in one of a first direction (for extension) or a second direction (for retraction).

Joint 309 can be coupled to joint 311. For example, in some implementations, joint 309 is mechanically coupled to joint 311. More specifically, a housing, bracket, or the like of joint 309 can be, for example, coupled (e.g., view screws, bolts, brackets, or any other suitable coupler) directly or indirectly to a housing, bracket, or the like of joint 311. In this manner, when the actuatable elongate member 310 is moved vertically with respect to the rail 308 at joint 311, joint 309 is also moved vertically. In some implementations, joint 309 is electrically coupled to join 311. In this manner, for example, joint 309 and joint 311 can share a power supply. In some implementations, an elevator described herein can include a track and drive gear or sprocket similar to that described herein with respect to the vertical movement of the actuatable elongate member 310.

At FIG. 5D, the actuatable elongate member 310 has been lifted up, along with package 335 and retracted away from the shelf 312 and towards the rail 308. As such, the actuatable elongate member 310, and the end portion 306 thereof particularly, is configured to move the package 304 within the drone pick-up and delivery system without also moving a shelf or other surface upon which the package 304 was disposed. In other words, the actuatable elongate member 310 can transfer solely the package within the system.

A similar but opposite process to that described for FIGS. 5A-5D can be followed for placing a package onto a shelf. If package 335 is on elongate members 332 for placing onto a shelf, elongate members 332 can be aligned to be at least partially above elongate openings 330. Once aligned, elongate members 332 can be lowered into elongate openings 330 until package 335 is resting on top of the uppermost edges of the side walls 336, 338 of elongate openings 330 and not on elongate members 332. Thereafter, the actuatable elongate member can retract away from the shelf 312 (in an opposite process to FIGS. 5E-5G).

Although the actuatable elongate arm 310 is shown and described herein as being movable in the first and/or second dimensions using a track and drive gear (or sprocket), in some implementations translational movement is differently achieved, for example via a rack and pinion gear, or other suitable translational or linear actuator.

Although each shelf (e.g., shelf 112, shelf 118, shelf 312, shelf 318) is shown and described herein as including one or more elongate openings defined by side walls and a bottom wall and being open at the top, in other embodiments, the elongate openings and/or elongate members can be differently configured. For example, in some embodiments, a shelf can include multiple elongate bars that extend horizontally from a rear plate or the like. Any suitable number of elongate bars can be included in the shelf, such as two to twenty elongate bars, or more specifically eight elongate bars. The elongate bars can be spaced apart along a horizontal plane such that the shelf defines elongate opening(s) between adjacent elongate bars. In some embodiments, a subset of the elongate bars (e.g., two adjacent or non-adjacent elongate bars) each includes an upwardly-extended end face. The height of the end face can be configured to prevent the package from being removed from the shelf by the elongate member unless the package has been elevated with respect to the upper shelf surface by a predetermined distance that is greater than the height of the end face of the elongate bars of the shelf. The height can be, for example, about 0.5 cm to about 3 cm.

In some embodiments, any shelf described herein can include a pair of elongate side bars that are vertically positioned above the upper surface of the shelf upon which the package can be disposed and horizontally spaced apart from each other by a distance that is equal to or wider than a maximum width of the upper surface of the shelf. The elongate side bars can be configured to limit lateral (e.g., left and/or right) displacement of the package with respect to the shelf. Each elongate side bar can be, for example, non-linear. More specifically, each elongate side bar can have a first portion that extends linearly from the rear plate of the shelf, for example, such that the first portion of the elongate side bar is substantially parallel to an elongate bar and/or elongate opening of the shelf. Each elongate side bar can have a second portion, distal to the first portion (on a free end opposite the rear plate) that has a centerline that is non-parallel to a centerline of the first portion of the elongate side bar. More particularly, the second end portion of each elongate side bar can be angled or otherwise bent or directed away from the shelf. In this manner, when the polar-axial robot is operated to rotate the rail (and thereby the actuatable elongate member), the actuatable elongate member can be substantially concurrently extended (for placement of the package on the shelf) (or retracted, for removal of the package from the shelf) at an earlier point in time than otherwise would be possible if the elongate side bars were linear and substantially equivalent in length to the elongate bars of the shelf. In other words, the outwardly angled second portions of the elongate side bars permits rotation of the end portion 106 and/or package on the end portion so that the package 106 can be place on (or removed from) the shelf without being directly on (or nearly directly on) the shelf, thereby increasing efficiency of movement of the polar-axial robot.

In an embodiment, an apparatus includes an actuatable elongate member (e.g., actuatable elongate member 310) having a distal end portion (e.g., end portion 306), the actuatable elongate member having a range of motion substantially along a first dimension between a retracted position and an extended position and having a range of motion substantially along a second dimension that is different from the first dimension and that includes a first position and a second position. The apparatus further includes a platform (e.g., platform 322) disposed at the distal end portion of the actuatable elongate member. The platform has a plurality of elongate members (e.g., elongate members 324), each elongate member from the plurality of elongate members being separated a non-zero distance amount from at least one adjacent elongate member from the plurality of elongate members. The plurality of elongate members is sized and shaped to have a complementary fit with a shelf having a plurality of elongate openings (e.g., elongate openings 326). The actuatable elongate member is configured to remove a package (e.g., package 304) from the shelf by (1) moving to the extended position and from the first position to a second position, and (2) then moving from the extended position to the retracted position while in the second position.

In some implementations of the apparatus, the shelf is a first shelf and the actuatable elongate member is configured to place the package on a second shelf by (1) moving to the extended position and (2) moving from the second position to a third position (e.g., associated with the second shelf, and which can be similar with respect to the second shelf as the first position is with respect to the first shelf).

In some implementations of the apparatus, the apparatus further includes a rail coupled to the actuatable elongate member. The actuatable elongate member has a range of motion relative to the rail that includes the first position and the second position. The actuatable elongate member has a centerline substantially along the first dimension. The rail has a centerline substantially along the second dimension. For example, in some implementations, the actuatable elongate member is elongate in a first dimension (e.g., along a first axis, e.g., an x-axis) while the rail is elongate in a second dimension (e.g., along a second axis, e.g., a z-direction).

In some implementations of the apparatus, each elongate opening from the plurality of elongate openings is defined by a first side wall for that elongate opening, a second side wall for that elongate opening and a bottom wall for that elongate opening disposed between the first side wall for that elongate opening and the second side wall for that elongate opening.

In some implementations of the apparatus, each elongate opening from the plurality of elongate openings is defined by a first side wall for that elongate opening, a second side wall for that elongate opening and a bottom wall for that elongate opening disposed between the first side wall for that elongate opening and the second side wall for that elongate opening. During operation, the actuatable elongate member moves (1) to the extended position while each elongate member from the plurality of elongate members is below an upper edge of the first side wall and an upper edge of the second side wall and above an upper surface of the bottom wall for each elongate opening from the plurality of elongate openings and (2) from the first position to the second position.

In some implementations of the apparatus, each elongate opening from the plurality of elongate openings is defined by a first side wall for that elongate opening, a second side wall for that elongate opening and a bottom wall for that elongate opening disposed between the first side wall for that elongate opening and the second side wall for that elongate opening. The actuatable elongate member is configured to remove the package from the shelf by: (1) moving to the extended position and from the first position to the second position while each elongate member from the plurality of elongate members is below an upper edge of the first side wall and an upper edge of the second side wall and above an upper surface of the bottom wall for each elongate opening from the plurality of elongate openings, and (2) moving from the extended position to the retracted position while each elongate member from the plurality of elongate members is above an upper edge of the first side wall, an upper edge of the second side wall and an upper surface of the bottom wall for each elongate opening from the plurality of elongate openings.

In some implementations of the apparatus, the shelf is a first shelf. The apparatus further includes a second shelf having a plurality of elongate openings. Each elongate opening from the plurality of elongate openings for the second shelf is defined by a first side wall for that elongate opening, a second side wall for that elongate opening and a bottom wall for that elongate opening disposed between the first side wall for that elongate opening and the second side wall for that elongate opening. The actuatable elongate member is configured to unload the package onto the second shelf by moving to the extended position and from the second position to the first position so that each elongate member from the plurality of elongate member is below an upper edge of the first side wall and an upper edge of the second side wall and above an upper surface of the bottom wall for each elongate opening from the plurality of elongate openings for the second shelf.

In some implementations of the apparatus, a system includes the apparatus. The system further includes a rail (e.g., rail 308) coupled to the actuatable elongate member. The actuatable elongate member has a range of motion relative to the rail that includes the first position and the second position. The system further includes a plurality of shelves that includes the shelf. Each shelf from the plurality of shelves has a plurality of elongate openings. The plurality of elongate members is sized and shaped to have a complementary fit with the plurality of elongate openings for each shelf from the plurality of shelves.

In an embodiment, a system includes an actuatable member (e.g., actuatable elongate member 310) having a distal end portion (e.g., end portion 306) and a range of motion between a retracted position and an extended position. The system further includes a platform (e.g., platform 322) disposed at the distal end portion of the actuatable member. The platform has a plurality of elongate members (e.g., elongate members 324). Each elongate member from the plurality of elongate members is separated a non-zero distance from at least one adjacent elongate member from the plurality of elongate members. The system further includes a rail (e.g., rail 308) coupled to the actuatable member. The actuatable member has a range of motion relative to the rail that includes a lower position and an upper position. The system further includes a plurality of shelves. Each shelf from the plurality of shelves has a plurality of elongate openings (e.g., elongate openings 326). The plurality of elongate members sized and shaped to have a complementary fit with the plurality of elongate openings for each shelf from the plurality of shelves.

In some implementations of the system, the plurality of shelves is disposed in arc pattern at a substantially common distance from the rail.

In some implementations of the system, the plurality of shelves includes a first shelf and a second shelf, a first package disposed on the first shelf, and a second package disposed on the second shelf. A size of the first package differs from a size of the second package. The actuatable member is configured to lift the first package from the first shelf at a first time. The actuatable member is configured to lift the second package from the second shelf at a second time different from the first time.

In some implementations of the system, the plurality of shelves includes a first shelf, a second shelf, a third shelf and a fourth shelf. The first shelf and the second shelf are disposed at a first location and a first radial distance from the rail. The first shelf is disposed above the second shelf. The third shelf and the fourth shelf are disposed at a second location and a second radial distance from the rail. The third shelf is disposed above the fourth shelf. The first location is different from the second location. The first radial distance is substantially equal to the second radial distance.

In some implementations of the system, the actuatable member is configured to lift a package from a shelf from the plurality of shelves by: (1) moving the actuatable member to the extended position and the lower position to cause the plurality of elongate members of the platform to complementarily fit within the plurality of elongate openings of the shelf, and (2) moving the actuatable member from the lower position to the upper position to cause the plurality of elongate members of the platform to be removed from the plurality of elongate openings of the shelf and to lift the package.

In some implementations of the system, the plurality of shelves includes a first shelf and a second shelf. The lower position is a first lower position and the upper position is a first upper position. The actuatable member is configured to move a package from the first shelf to the second shelf by: (1) moving the actuatable member to the extended position and the first lower position to cause the plurality of elongate members of the platform to complementarily fit within the plurality of elongate openings of the first shelf, (2) moving the actuatable member from the first lower position to the first upper position to cause the plurality of elongate members of the platform to be removed from the plurality of elongate openings of the first shelf and to lift the package, (3) moving the actuatable member while carrying the package to the extended position and a second upper position to cause the plurality of elongate members of the platform to complementarily fit within the plurality of elongate openings of the second shelf, and (4) moving the actuatable member to the retracted position and from the second upper position to a second lower position to cause the plurality of elongate members of the platform to be removed from the plurality of elongate openings of the second shelf and to leave the package on the second shelf.

In some implementations of the system, the lower position is a first lower position, the upper position is a first upper position, and the actuatable member configured to move a package, from a shelf from the plurality of shelves to an access shelf, by: (1) moving the actuatable member to the extended position and the first lower position to cause the plurality of elongate members of the platform to complementarily fit within the plurality of elongate openings of the shelf, (2) moving the actuatable member from the first lower position to the first upper position to cause the plurality of elongate members of the platform to be removed from the plurality of elongate openings of the shelf and to lift the package, (3) moving the actuatable member while carrying the package to the extended position and a second upper position to cause the plurality of elongate members of the platform to complementarily fit within a plurality of elongate openings of the access shelf, and (4) moving the actuatable member from the second upper position to a second lower position and then to the retracted position to cause the plurality of elongate members of the platform to be removed from the plurality of elongate openings of the access shelf and to leave the package on the access shelf. In some implementations, the access shelf is associated with one of (1) an elevator having a range of motion that includes access to a drone landing pad or (2) a portal through which packages can be received and delivered.

In an embodiment, a method includes moving an actuatable member (e.g., actuatable elongate member 310) to an extended position and a lower position to cause a plurality of elongate members (e.g., elongate members 324) of a platform (e.g., platform 322) to complementarily fit within a plurality of elongate openings (e.g., elongate openings 326) of a shelf. The platform is coupled to a distal end portion (e.g., end portion 306) of the actuatable member. A package (e.g., package 304) is disposed on the shelf. The method further includes moving, after the moving the actuatable member to the extended position and the lower position, the actuatable member from the lower position to an upper position to cause the plurality of elongate members of the platform to be removed from the plurality of elongate openings of the shelf and to lift the package from the shelf.

In some implementations of the method, the lower position is a first lower position and the upper position is a first upper position. The method further includes moving, after the moving the actuatable member to the first upper position, the actuatable member while carrying the package to a retracted position. The method further includes moving, after the moving the actuatable member to the retracted position, the actuatable member while carrying the package to the extended position and a second upper position to cause the plurality of elongate members of the platform to complementarily fit within the plurality of elongate openings of the second shelf. The method further includes moving, after the moving the actuatable member to the extended position and the second upper position, the actuatable member to the retracted position and from the second upper position to a second lower position to cause the plurality of elongate members of the platform to be removed from the plurality of elongate openings of the second shelf and to leave the package on the second shelf.

In some implementations of the method, the lower position is a first lower position and the upper position is a first upper position. The method further includes moving, after the moving the actuatable member to the first upper position, the actuatable member while carrying the package to a retracted position. The method further includes moving, after the moving the actuatable member to the retracted position, the actuatable member while carrying the package to the extended position and a second upper position to cause the plurality of elongate members of the platform to complementarily fit within a plurality of elongate openings of an access shelf. The method further includes moving, after the moving the actuatable member while carrying the package to the extended position and the second upper position, the actuatable member from the second upper position to a second lower position and then to the retracted position to cause the plurality of elongate members of the platform to be removed from the plurality of elongate openings of the access shelf and to leave the package on the access shelf.

In some implementations of the method, the access shelf is associated with one of (1) an elevator (e.g., elevator 120) having a range of motion that includes access to a drone landing pad (e.g., landing pad 116) or (2) a portal (e.g., portal 102) through which packages can be received and delivered.

### Package Acceptance System

Some implementations are related to a receptacle of a package acceptance system (PAS) of a drone pick-up and delivery system (e.g., including a container described herein, such as container 100). The PAS can include and/or be configured for use with a customer access portal (e.g., portal 102). For example, the customer access portal can be used to place a package within the receptacle of the PAS. The PAS receptacle can determine whether a package inserted into the PAS receptacle (e.g., via customer access portal) is capable of being shipped by a drone (e.g., based on automatically obtained measurements associated with the package such as total weight, weight distribution, center of gravity, dimensions, and/or the like).

FIG. 6A shows a perspective view of a container that includes PAS receptacle 500, according to an embodiment. The container can include PAS receptacle 500, landing pad 503 (e.g., similar to landing pad 116), and interface 507. In some implementations, a package 505 can be placed in receptacle 500 for storage and/or transfer to a drone via landing pad 503. In some implementations, a package 505 can be picked up/retrieved from receptacle 505 (e.g., by a human) after the package 505 has been delivered by a drone.

FIG. 6B shows a perspective view of the PAS receptacle 500. The receptacle 500 can include a chamber 510 for holding package 505, as well as one or more actuatable structures (e.g., walls, wall portions, arms, rods, etc., or a combination of the foregoing) that can move the package within the chamber. Said differently, the receptacle 500 can include a chamber configured to receive package 505. For example, a user can place package 505 in the chamber of the receptacle 500 of the PAS. Package 505 is shown in FIGS. 6A and 6B in solid, with another larger package shown transparent, which reflects the ability of the PAS to accept packages of varying size, within a predetermined size range. The receptacle 500 can also include one or more actuatable structures. The actuatable structures can move package 505 within the chamber of receptacle 500 to a predetermined position (e.g., predetermined location and/or predetermined orientation) so that information about package 505 can be collected (e.g., by an internal scanner, optical reader, tag reader, and/or the like).

In some implementations, receptacle 500 can include a platform 508 to receive packages thereon. The receptacle 500 can also include at least one of an actuatable (or adjustable) rear structure 512, actuatable (or adjustable) left structure 514, or actuatable (or adjustable) right structure 516 configured to move package 505 to a predetermined and known position (e.g., in x, y, and z coordinates) on the platform 508 of receptacle 500 so that package 505 can be stored for later retrieval by a drone and/or retrieved by a drone without storing by a polar-axial robot. In some implementations, the predetermined position is determined (e.g., by a processor) based on the size of package 505, where the size can be determined without human interaction (e.g., using a camera, using sensors, scanning a barcode or label on package 505, etc.) and/or with human interaction (e.g., manual input by a user).

In some implementations, the platform 508 of receptacle 500 can also include weight sensors to measure weight, such as load cells (e.g., three load cells). For example, as schematically shown in FIG. 6C, load cells LC1, LC2 and LC3 can be positioned under the platform 508 and communicably coupled to hardware of receptacle 500 that includes a processor 542 and a memory 544 communicably coupled to the processor. The sensor (or load cell) measurements can be used (e.g., by the processor) to determine a weight and/or center of gravity of package 505. Although three load cells are illustrated in FIG. 6C, in some implementations, one, two, four or more load cells or other sensors can be used.

In some implementations, package 505 may include information that PAS receptacle 500 can retrieve. For example, package 505 may include a visual code (e.g., QR code on a label on the package) that can be scanned (e.g., by a camera, by an NFC reader, and/or the like) indicating dimensions, center of gravity, weight, and/or the like of package 505. In some implementations, after determining the information, PAS receptacle 500 can use the load cell measurements and/or dimensions measured by moving package 505 to a predetermined position in the chamber of the receptacle 500 via one or more actuatable walls 512, 514, and/or 516 to determine dimensions, center of gravity, weight, and/or the like; if one or more measurements differ from the expected measurements, PAS receptacle 500 can perform a remedial action, such as declining acceptance of package 505.

In some implementations, receptacle 500 includes a door (not shown in FIGS. 6A-6B, but which can be similar or identical to door 1111 shown in FIG. 11) that can open and close (e.g., so that package 505 can be placed within the chamber of the receptacle 500). For example, the door can remain closed until an indication is received (e.g., a button is pressed, a code is scanned, etc.) for the door to open. As another example, a user can manually open the door. In some embodiments, the door is configured to stay in a locked position until the indication is received.

In some implementations, interface 507 can be used by a user to interact with (e.g., provide information to) receptacle 500. Interface 507 could include, for example, a display, keypad, microphone, speaker, camera, scanner, biometric reader, and/or the like. In one example, interface 507 can be used by a user to provide information about package 505, such as the package's 505 weight, dimension, product code, prepaid shipping label, and/or the like, or the user, such as the user's name other or identification, payment information, and/or the like. Interface 507 can also provide information to a customer, such as if package 505 has been accepted for shipping or not.

In some implementations, receptacle 500 includes a first actuatable structure (e.g., wall or wall portion 514) that can move along a first dimension. In some implementations, receptacle 500 further includes a second actuatable structure (e.g., wall or wall portion 516) that can move along the first dimension (or substantially along the first dimension for example depending on the manufacturing and tolerance variations of the actuatable walls). In some implementations, receptacle 500 further includes a third actuatable structure (e.g., wall or wall portion 512) that can move along a second dimension (e.g., substantially perpendicular to the first dimension). In some implementations, receptacle 500 further includes a fourth actuatable structure (not shown in FIG. 6B) that can move in the second dimension (or substantially along the second dimension for example depending on the manufacturing and tolerance variations of the actuatable walls). For example, the first and second actuatable structures can be configured to move left and right, while the third and fourth actuatable structures can be configured to move forward and backwards.

In some implementations, an actuatable structure portion forms a rear wall (e.g., wall 512) of the chamber of receptacle 500 opposite a port (e.g., similar to portal 102) through which the package is insertable into the chamber. In some implementations, the rear wall can be actuated to be removed and provide access to the polar-axial robot (e.g., after package 505 has been accepted and verified) so that a polar-axial robot can obtain package 505 and store and/or transfer package 505 to a drone.

In some implementations, receptacle 500 receives package 505 (e.g., from a human) and determines an attribute (e.g., weight, center of gravity, size, unique identifier, etc.) of package 505. Thereafter, the attribute can be compared to a reference, such as information provided by a user via interface 507, information provided by the seller, and/or the like. If the attribute and reference are different, the container can perform a remedial action. For example, receptacle 500 can refrain from receiving package 505 and/or causing package 505 to be stored in the container. As another example, an error message can be output (e.g., via interface 507, a speaker, etc.) for the user (e.g., human) that dropped off package 505.

In some implementations, receptacle 500 is used to provide package 505 to a human for retrieval. Receptacle 500 receives package 505 (e.g., from the polar axial robot) and determines an attribute (e.g., weight, center of gravity, size, unique identifier, etc.) of package 505. Thereafter, the attribute can be compared to a reference, such as information provided by a user via interface 507, information provided by the seller, the attribute of the package 505 when it was received at receptacle 500, and/or the like. If the attribute and reference are different, the container can perform a remedial action. For example, receptacle 500 can refrain from allowing the human to retrieve package 505 and/or causing package 505 to be reshelved. As one example, if package 505 weighed five pounds when it was delivered to the container, receptacle 500 can weigh package 505 to verify that the weight is still five pounds prior to allowing someone to retrieve the package 505; a difference or amount of difference in the weight may indicate, for example, that package 505 is the wrong package, that something leaked, fell out of, or was removed from package 505, and/or the like.

Although not explicitly shown in FIGS. 6A-6C, receptacle 500 can include one or more controllers for controlling functions of receptacle 500. For example, the controller can cause a door of receptacle 500 to open (e.g., to pick up or drop off a package), actuatable structures (e.g., walls) to move via their associated actuators, measurements (e.g., weight, center of gravity, dimensions, etc.) of the package to be performed, and/or the like.

In some implementations, each of the one or more controllers can include a processor (e.g., processor 542) and a memory (e.g., memory 544) operatively coupled to the processor. The processor can be, for example, a hardware based integrated circuit (IC), or any other suitable processing device configured to run and/or execute a set of instructions or code. For example, the processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor can be configured to run any of the methods and/or portions of methods discussed. The memory can be, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory can include extendable storage units that can be added and used incrementally. In some implementations, the memory can be a portable memory (e.g., a flash drive, a portable hard disk, and/or the like) that can be operatively coupled to the processor. In some instances, a memory can be remotely operatively coupled with a compute device (not shown).

In some implementations, the memory includes a representation of instructions (e.g., code) that can be used to control the receptacle 500. In some implementations, the instruction can include code to cause, via the processor, one or more actuators to move at one or more times for certain periods of time in one or more sequences to carry out the techniques described herein. For example, the instructions can include code to cause the processor to send a first electronic signal to a first actuator(s) that can control a first actuatable structures, cause the processor to send a second electronic signal to a second actuatable structure, cause the processor to send a third electronic signal to a third actuatable structure, and cause the processor to send a fourth electronic signal to a fourth actuatable structure.

In an embodiment, an apparatus includes a receptacle (e.g., receptacle 500) at least partially disposed in a package repository having access to a drone landing pad (e.g., landing pad 503). The receptacle defines a chamber configured to receive a package (e.g., package 505) therein from a user. The apparatus further includes a first actuatable wall portion (e.g., wall or wall portion 514) movably coupled to a first side of the receptacle, the first actuatable wall portion configured to move in a first direction into the chamber when the first actuatable wall portion is actuated. The apparatus further includes a second actuatable wall portion (e.g., wall or wall portion 516 or wall or wall portion 512) movably coupled to a second side of the receptacle, the second actuatable wall portion configured to move in a second direction, different from the first direction, into the chamber when the second actuatable wall portion is actuated. The first actuatable wall portion and the second actuatable wall portion can be collectively configured to move, when the first actuatable wall portion is moved in the first direction and the second actuatable wall portion is moved in the second direction, the package received in the chamber into a predetermined position with respect to the receptacle.

In some implementations of the apparatus, the predetermined position includes a location with respect to the chamber and an orientation with respect to the chamber.

In some implementations of the apparatus, the first side of the receptacle is substantially opposite the second side of the receptacle. The first actuatable wall portion is configured to move towards the second actuatable wall portion when the first actuatable wall portion is moved in the first direction. The second actuatable wall portion is configured to move towards the first actuatable wall portion when the second actuatable wall portion is moved in the second direction.

In some implementations of the apparatus, the apparatus further includes an actuator (e.g., actuator 520 shown in FIG. 6B) coupled to the receptacle and disposed external to the chamber. The apparatus further includes an elongate member (e.g., elongate member 522 shown in FIG. 6B) coupled between the actuator and the first actuatable wall portion and disposed external to the chamber. The actuator configured to move the elongate member in a direction away from a vertical centerline of the chamber causing the elongate member to move the first actuatable wall portion in the first direction and towards the vertical centerline of the chamber.

In some implementations of the apparatus, the receptacle 500 includes a top 532, a bottom 534, a first sidewall 536 and a second sidewall 538. The first side of the receptacle includes the first sidewall of the receptacle, the second side of the receptacle includes the second sidewall of the receptacle, the first actuatable wall portion 514 extends through the first sidewall 536, and the second actuatable wall portion 516 extends through the second sidewall 538.

In some implementations of the apparatus, the apparatus further includes a platform (e.g., platform 508) at least partially disposed within the chamber. The platform is coupled to and disposed spaced apart a non-zero distance from a bottom 534 of the receptacle. The platform has a surface configured for the package to be disposed thereon.

In some implementations of the apparatus, the apparatus further includes a platform disposed within the chamber such that the platform is spaced apart a non-zero distance from a bottom of the receptacle. The platform has a surface configured for the package to be disposed thereon. The apparatus further includes a force sensor coupled to the platform. The force sensor is configured to measure a mass of the package disposed on the platform. The apparatus further includes a processor operably coupled to the sensor. The processor is configured to automatically determine a first position of the package with respect to the platform when the package is disposed on the platform based on information received from the sensor. The processor is configured to automatically selectively actuate each of the first actuatable wall portion and the second actuatable wall portion based on the determined first position to move the package to the predetermined position.

In some implementations of the apparatus, the apparatus further includes a third actuatable wall portion movably coupled to a third side of the receptacle between the first side of the receptacle and the second side of the receptacle. The third actuatable wall portion is configured to move in a third direction that is substantially perpendicular to the first direction, into the chamber when the third actuatable wall portion is actuated. The first actuatable wall portion, the second actuatable wall portion and the third actuatable wall portion can be collectively configured to move, when (1) the first actuatable wall portion is moved in the first direction, (2) the second actuatable wall portion is moved in the second direction, and (3) the third actuatable wall portion is moved in the third direction, the package received in the chamber into the predetermined position with respect to the receptacle.

In some implementations of the apparatus, the apparatus further includes a third actuatable wall portion movably coupled to a third side of the receptacle between the first side of the receptacle and the second side of the receptacle. The third actuatable wall portion is configured to move in a third direction into the chamber when the third actuatable wall portion is actuated. The third actuatable wall portion forms a rear wall of the chamber opposite a port through which the package is insertable into the chamber.

In some implementations of the apparatus, the second actuatable wall portion forms a rear wall of the chamber opposite a port through which the package is insertable into the chamber. The second actuatable wall portion is configured to be automatically movably displaced for the package to be retrieved from the chamber and moved into the package repository by an automated robotic arm of the package repository.

In an embodiment, an apparatus includes a receptacle (e.g., receptacle 500) at least partially disposed in a package repository having access to a drone landing pad (e.g., landing pad 503). The receptacle can define a chamber configured to receive a package (e.g., package 505) therein. The apparatus can further include a platform disposed within the chamber such that the platform is spaced apart a non-zero distance from a bottom of the receptacle. The platform can have a surface configured for the package to be disposed thereon. The apparatus can further include a sensor coupled to the platform. The sensor can be configured to measure force or weight data associated with the package being disposed on the platform. The apparatus can further include a processor configured to receive, from the sensor, a signal associated with the force or weight data associated with the package. The processor can be configured to automatically (e.g., without human interaction) calculate a center of mass of the package based on the signal.

In some implementations of the apparatus, the sensor is configured to measure force or weight data associated with the package being disposed on the platform in a first position. The apparatus can further include an actuator operably coupled to the processor and coupled to the receptacle. The processor can be configured to send a signal to the actuator to move the package to a second position in which the center of mass of the package is disposed substantially at a predetermined position on the surface of the platform.

In some implementations of the apparatus, the sensor includes at least three load cells, and the platform is mounted on the at least three load cells.

In some implementations of the apparatus, the receptacle includes a movable wall defining a rear side of the chamber (e.g., wall or wall portion 512) opposite a port through which the package is insertable into the chamber. The movable wall can be configured to be movably displaced for retrieval of the package from the chamber by an automated robotic arm of the package repository.

In some implementations of the apparatus, the receptacle includes an actuatable wall portion that forms a portion of at least one of a sidewall or a rear wall of the chamber. The actuatable wall portion is configured to move the package within the chamber and on the platform to a second position with respect to the surface of the platform. The processor is configured to calculate the center of mass of the package in the second position based on an updated signal from the sensor.

In some implementations of the apparatus, the apparatus further includes a plurality of actuatable wall portions that form at least a portion of the chamber. The plurality of actuatable wall portions can be selectively actuatable in response to the processor's calculation of the center of mass of the package with respect to the surface of the platform to contact the package and adjust the position of the center of mass of the package with respect to the surface of the platform.

In an embodiment, a method includes receiving, from a plurality of sensors, a plurality of signals associated with a mass of a package (e.g., package 505) received in a first position on a platform in a receptacle (e.g., receptacle 500) coupled to a package repository and having access to a drone landing pad (e.g., landing pad 503). The method further includes calculating a center of mass of the package with respect to the platform. The method further includes actuating, in response to the calculating, a first actuatable wall portion to move the package in a first direction with respect to the platform. The method further includes actuating, in response to the calculating, a second actuatable wall portion to move the package in a second direction with respect to the platform. The actuating the first actuatable wall portion and the actuating the second actuatable wall portion can collectively move the package towards a second position on the platform to locate the center of mass of the package at a predetermined position with respect to the platform.

In some implementations of the method, the first actuatable wall portion forms at least a portion of a rear wall of the receptacle, and the second actuatable wall portion forms at least a portion of a sidewall of the receptacle. The rear wall can be substantially perpendicular to the side wall.

In some implementations of the method, the method further includes determining a mass of the package when the package is received on the platform. The method further includes providing an indication that the package is not acceptable when at least one of (1) the package exceeds a predetermined mass, or (2) the package cannot be moved with respect to the platform so that so that the center of mass of the package is located at the predetermined position with respect to the platform.

In some implementations of the method, the first actuatable wall portion forms at least a portion of a rear wall of the receptacle. The method further includes moving, after the actuating the first actuatable wall portion and after the actuating the second actuatable wall portion, the first actuatable wall portion with respect to the receptacle to produce a port through which the package is movable from the receptacle and to one of the package repository or drone landing pad, only when (1) actuation of each of the first actuatable wall portion and the second actuatable wall portion collectively moved the package to the second position on the platform to locate the center of mass of the package at the predetermined position with respect to the platform, and (2) a mass of the package does not exceed a predetermined threshold.

### Access Door of a Landing Pad

Some implementations are related to a landing pad access door that is configured to seal off an access portal of a drone landing pad. For example, a landing pad access door can be part of landing pad 116 of FIG. 1, where the landing pad access door can open so that a package can be placed in container 100 for internal transfer (e.g., storage in a package repository, placing in a customer access portal, placing on an elevator, and/or the like).

FIGS. 7A-7C, 8, and 9A-9B show a door panel 712 and a cover 716 coupled to door panel 712 of a landing pad access door 700 moving from a closed position (e.g., FIG. 7A) to an open position (e.g., FIG. 7C). The landing pad access door 700 includes door panel 712, cover 716, stationary rail 710a, and stationary rail 710b.

Stationary rail 710a defines a first channel 702 and a second channel 704. The first channel 702 includes first elongate portion 702a and a second elongate portion 702b. The second channel 706 includes a first elongate portion 706a and a second elongate portion 706b.

Similarly, the stationary rail 710b defines a first channel 704 and a second channel 708, which can be substantially identical to (or a mirror image of) the first channel 702 and second channel 706, respectively of stationary rail 710a. The first channel 704 includes a first elongate portion 704a and a second elongate portion 704b. The second channel 708 includes a first elongate portion 708a and a second elongate portion 708b.

Door panel 712 can slide along stationary rails 710a and 710b via first elongate portion 702a of the first channel 702, second elongate portion 702b of the first channel 702, first elongate portion 706a of second channel 706, second elongate portion 706b of second channel 706, first elongate portion 704a of first channel 704, second elongate portion 704b of first channel 704, first elongate portion 708a of second channel 708, and second elongate portion 708b of second channel 708.

For stationary rail 710a, first elongate portion 702a of the first channel 702, second elongate portion 702b of the first channel 702, first elongate portion of second channel 706a, and second elongate portion of second channel 708a are each substantially (e.g., within 5%, within 10%, within 25%, etc.) linear. First elongate portion 702a of the first channel 702 is substantially perpendicular to second elongate portion 702b of the first channel 702. First elongate portion 706a of second channel 706 is diagonal relative to second elongate portion 706b of second channel 706.

For stationary rail 710b, first elongate portion 704a of first channel 704, second elongate portion 704b of first channel 704, first elongate portion 708a of second channel 708, and second elongate portion 708b of second channel 708 are each substantially (e.g., within 5%, within 10%, within 25%, etc.) linear. First elongate portion 704a of first channel 704 is substantially perpendicular to second elongate portion 704b of first channel 704. First elongate portion 708a of second channel 708 is diagonal relative to second elongate portion 708b of second channel 708.

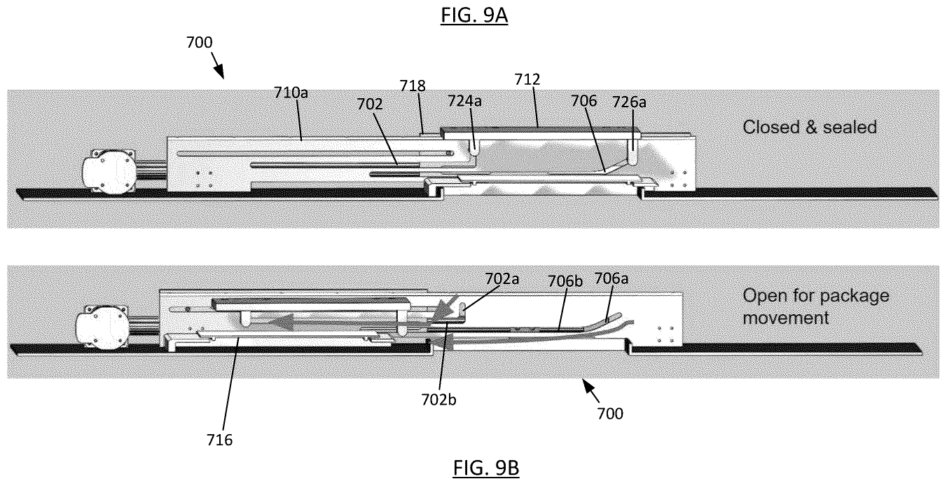

Though not shown in FIGS. 7A-7C, but labelled in FIG. 9A, protrusions (e.g., protrusions 724a, 726a) can be coupled to door panel 712. Each protrusion can be configured to attach and slide on a channel of a stationary rail. For example, a first protrusion can be configured to attach to and slide on the first channel 702 of stationary rail 710a, a second protrusion can be configured to attach to and slide with respect to the second channel 706of stationary rail 710a, a third protrusion can be configured to attach to and slide with respect to the first channel 704 of stationary rail 710b, a fourth protrusion can be configured to attach to and slide with respect to the second channel 708 of stationary rail 710b.

During movement of door panel 712, the first protrusion is configured to move with respect to the first channel before the second protrusion is moved with respect to the second channel.

FIG. 7A shows door panel 712 and cover 716 in a closed position, FIG. 7B shows door panel 712 and cover 716 transitioning between an open position and the closed position, and FIG. 7C shows door panel 712 and cover 716 in the open position.

In the closed position shown in FIG. 7A, an access portal of a package destination repository (e.g., container 100) is not accessible. Said differently, in the closed position, a package cannot be moved inside a container (e.g., container 100) via a drone landing pad (e.g., landing pad 116). In the closed position, the door panel 712 can be substantially (e.g., within 5%, within 10%, within 25%, etc.) co-planar with the remainder of an upper surface of the drone or unmanned aerial vehicle (UAV) landing pad.

When transitioning from the closed position to the open position, as shown in FIG. 7B, the one end of door panel 712 (shown as in FIG. 7B as the left, or leading, end) is tilted downward (e.g., towards a cover 716 disposed beneath the door panel) relative to the other end of door panel 712 (shown as in FIG. 7B as the right, or trailing, end) for a non-zero period of time. Two protrusions on the one end of door panel 712 first slide downwards along first elongate portions 702a, 704a of first channels 702, 704, respectively, before the two protrusions on the other end of door panel 712 begin to slide along first elongate portions 706a, 708a of second channels 706, 708, respectively.

Once the protrusions on the one end of the door panel 712 are at an intersection of the first elongate portion 702a, 704a of the first channels 702, 704, respectively, and the second elongate portions 702b, 704b of the first channels 702, 704, respectively, the protrusions can move laterally with respect to the second elongate portions 702b, 704b of the first channels 702, 704. In a concurrent process with lateral movement of the protrusions on the one end of the door panel 712, the protrusions on the other end of the door panel 712 can move diagonally with respect to the first elongate portions 706a, 708a of the second channels 706, 708, respectively, and then laterally with respect to the second elongate portions 706b, 708b of the second channels 706, 708. The reverse process can occur when transitioning from the open position to the closed position.

In the open position shown in FIG. 7C, door panel 712 and cover 716 are positioned so that there is an opening (corresponding to the positions of the door 712 and cover 716 in the closed position as shown in FIG. 7A). This opening can be where packages are transferred in and/or out of.

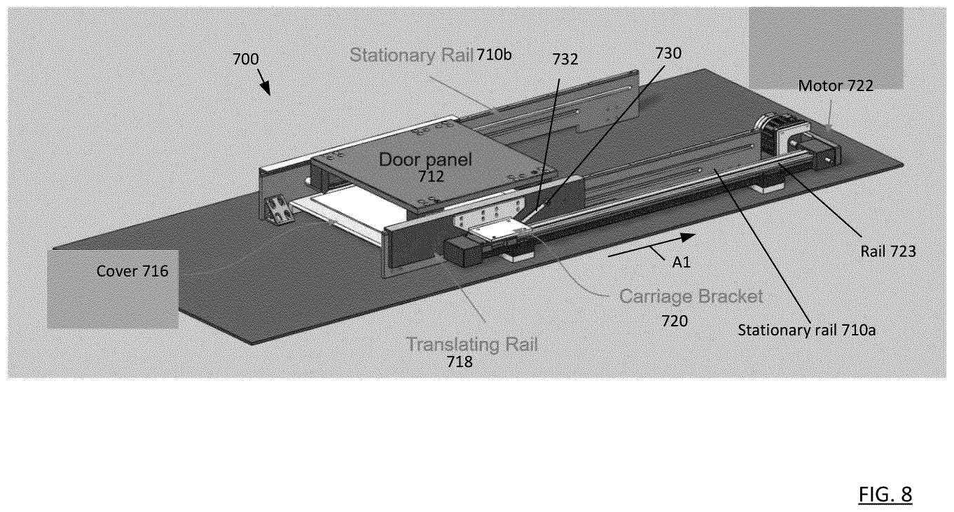

FIG. 8 shows another view of a landing pad access door 700, according to an embodiment. In FIG. 8, door panel 712 and cover 716 are in the closed position. When an indication has been received via a receiver, transceiver and/or the like to move from the closed position to the open position, such as an electronic signal received from drone or drone controller, a controller can cause motor 722 to turn on so that door panel 712 and cover 716 slide along stationary rails 710a and 710b via translating rail 718 (e.g., in the direction of arrow A1, shown in FIG. 8). Carriage bracket 720 can be operatively coupled between the door panel 712 and motor 722, and more specifically to a motor rail 723 between the translating rail 718 and the motor 722. The motor rail 723 includes a belt. The belt is coupled to a carriage (not shown in FIG. 8) that is coupled to carriage bracket 720. The motor 722 can be configured to rotate to move the belt, which in turn moves the carriage and thus the carriage bracket 720. During movement of the door panel 712 to the open position, the carriage bracket 720 causes the translating rail 718 to move in the direction of arrow A1 (FIG. 8). As the translating rail 718 moves, a cam slot 732 defined by the translating rail 718 and through which a cam follower bearing 730 coupled to the protrusion on the one end of the door panel 712 is disposed, moves past the protrusion until an end of the cam slot 732 engages the cam follower bearing 730 and forces the protrusion to move. The cam slot 732 causes or permits the protrusion to lower within the first elongate portion 702a of the first channel 702 when the cam slot 732 is moved with respect to the cam follower bearing 730 in the direction of arrow A1. Conversely, when the translating rail 718 is moved in a direction opposite that of arrow A1, the cam slot 732 causes the cam follower bearing 730 to be raised into the first elongate portion 702a of the first channel 702, to move the door panel to the closed position.

In some implementations, the motor rail 723 can include, for example, a worm drive that causes a gear to rotate and the gear rotation in turn can cause a spiral gear extended through a channel in motor rail 723 to rotate, thereby moving carriage bracket 720 with respect to the motor rail 723 based on the rotation and direction of rotation of the spiral gear. In some implementations, motor 722 is or can include a Teknic® motor. In some implementations, rail 723 is or can include an Igus® rail.

The carriage bracket 720, which is coupled to translating rail 718, thereby causes movement (e.g., opening or closing) of the door panel coupled to the translating rail 718. Carriage bracket 720 is configured to move door panel 712 with respect to stationary rails 710a and 710b in response to an actuation of motor 722 such that a first end portion of the door panel 712 is lowered via the first channel (e.g., towards cover 716 positioned below and substantially parallel to the door) and then the door panel 712 is moved in a substantially lateral direction, as described in more detail herein.

FIGS. 9A and 9B show a side, cross-sectional view of a landing pad access door 700 in a closed position and an open position, respectively, according to an embodiment. Although FIGS. 9A and 9B only show a single stationary rail, there can be a substantially similar structure at the other stationary rail.

FIGS. 9A and 9B shows protrusions 724a and 726a coupled to door panel 712. FIGS. 9A and 9B also show the cover 716, first elongate portion 702 of first channel 702, second elongate portion 702b of first channel 702, first elongate portion 706a of second channel 706, and second elongate portion 706b of second channel 706. Note that, in this example, protrusion 726a is longer than protrusion 724a. Protrusions 724a and 726a can be substantially linear. Protrusions 724a and 726a can each include a vertical portion that extends downwardly from a lower surface of the door panel 712. In some implementations, the translating rail 718 can include protrusions (not shown) that extend through channels 702, 706, respectively, to engage with or otherwise be coupled to an end portion of the protrusions 724a, 726a, respectively. In some implementations, protrusions 724a, 726a can each include a horizontal portion (e.g., a cam follower bearing coupled to the protrusion) that extends laterally from the vertical portion of the protrusion, at least partially through the respective channel 702, 706, which horizontal portions can be movably coupled to the translating rail 718.

In the closed position shown at FIG. 9A, protrusion 724a is at the first elongate portion 702a of the first channel 702, and protrusion 726a is at the first elongate portion 706a of second channel 706. In the open position shown at FIG. 9B, door panel 712 has, via protrusions 724a and 726a, slid down first elongate portion 702a of first channel 702 and first elongate portion 706a of second channel 706, respectively, and laterally along second elongate portion 702b of first channel 702 and second elongate portion 706b of second channel 706, respectively. Because at least one of the door panel 712 or the translating rail 718 is coupled to cover 716, cover 716 is also moved into the open position with door panel 712.

Although not explicitly shown in FIGS. 7A-7C, 8, or 9A-9B, a landing pad access door (e.g., landing pad access door 700) can include one or more controllers for controlling functions of the landing pad access door. For example, the controller can control a motor (e.g., motor 722) to cause a door panel (e.g., door panel 712) to move.

In some implementations, each of the one or more controllers can include a processor and a memory operatively coupled to the processor. The processor can be, for example, a hardware based integrated circuit (IC), or any other suitable processing device configured to run and/or execute a set of instructions or code. For example, the processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor can be configured to run any of the methods and/or portions of methods discussed. The memory can be, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory can include extendable storage units that can be added and used incrementally. In some implementations, the memory can be a portable memory (e.g., a flash drive, a portable hard disk, and/or the like) that can be operatively coupled to the processor. In some instances, a memory can be remotely operatively coupled with a compute device (not shown).

In some implementations, the memory includes a representation of instructions (e.g., code) that can be used to control the receptacle 500. In some implementations, the instruction can include code to cause, via the processor, one or more motors to move at one or more times for certain periods of time in one or more sequences to carry out the techniques described herein.

In an embodiment, an apparatus includes a stationary rail (e.g., stationary rail 710a or 710b) including a first channel and a second channel. At least a portion of the first channel is located above at least a portion of the second channel. The apparatus further includes a door panel (e.g., door panel 712) coupled to the stationary rail. The door panel is slidingly movable with respect to the first channel and the second channel from a first position with respect to the stationary rail to a second position with respect to the stationary rail different from the first position. The door panel has an upper surface that is substantially co-planar with an upper surface of an unmanned aerial vehicle (UAV) landing pad (e.g., landing pad 116) when the door panel is in the first position. The door panel in the second position is lower than the upper surface of the UAV landing pad and laterally offset with respect to the first position such that an opening in the UAV landing pad is exposed. The opening is configured to permit a package to be passed therethrough.

In some implementations of the apparatus, the door panel includes a first protrusion (e.g., protrusion 724a) extended from a first end portion of a lower surface of the door panel. The first protrusion is moveable with respect to the first channel of the stationary rail. The door panel includes a second protrusion (e.g., protrusion 726a) extended from a second end portion of the lower surface of the door panel. The second protrusion is moveable with respect to the second channel of the stationary rail. The second end portion is opposite the first end portion. During movement of the door panel from the first position towards the second position, the first protrusion is configured to move with respect to the first channel before the second protrusion is moved with respect to the second channel.

In some implementations of the apparatus, the door panel includes a first protrusion (e.g., protrusion 724a) extended from a lower surface of the door panel at a first end portion of the door panel. The first protrusion is moveable with respect to the first channel of the stationary rail. The door panel includes a second protrusion (e.g., protrusion 726a) extended from the lower surface of the door panel at a second end portion of the door panel. The second protrusion is moveable with respect to the second channel of the stationary rail. The second end portion is opposite the first end portion. The first protrusion is shorter in length than the second protrusion such that the first protrusion and the first end portion of the door panel is configured to be lowered vertically before the second protrusion is moved laterally with respect to the second channel during movement of the door panel from the first position to the second position.

In some implementations of the apparatus, the apparatus further includes an actuator (e.g., motor 722) and a carriage bracket (e.g., carriage bracket 720) operatively coupled between the door panel and the actuator. The carriage bracket is configured to move the door panel with respect to the stationary rail in response to an actuation of the actuator by lowering a first end portion of the door panel via the first channel towards a cover (e.g., cover 716) positioned below and substantially parallel to the door panel; and laterally sliding the door panel via the first channel and the second channel to expose an access portal of a package destination repository.

In some implementations of the apparatus, the apparatus further includes a cover (e.g., cover 716) operatively coupled to the door panel. The cover has a closed position in which the cover blocks access to an access portal of a package destination repository and an open position in which the cover is spaced apart from the access portal. The cover is configured to be automatically moved from the closed position to the open position in response to the door panel being moved from the first position to the second position.

In some implementations of the apparatus, the apparatus further includes a cover (e.g., cover 716) operatively coupled to the door panel. The cover has a closed position in which the cover blocks access to an access portal of a package destination repository and an open position in which the cover is laterally offset from the access portal. The apparatus further includes a translating rail (e.g., translating rail 718) disposed on the stationary rail and moveable with respect to the stationary rail. The translating rail is coupled to the door panel and the cover. The translating rail is configured to move the cover from the closed position to the open position when the door panel is moved from the first position to the second position.

In some implementations of the apparatus, the first channel includes a first elongate portion (e.g., first elongate portion 702a of the first channel 702) that is substantially perpendicular to a second elongate portion (e.g., second elongate portion 702b of the first channel 702) of the first channel. The second elongate portion of the first channel is substantially horizontal. The apparatus further includes a protrusion (e.g., protrusion 724a) coupled to the door panel. The protrusion is positioned with respect to the first elongate portion of the first channel when the door panel is in the first position such that the protrusion is lowered vertically with respect to the first elongate portion of the first channel before the protrusion can be moved laterally with respect to the second elongate portion of the first channel during movement of the door panel from the first position to the second position.

In some implementations of the apparatus, the second channel includes a first elongate portion (e.g., first elongate portion 706a of second channel 706) that is diagonal to a second elongate portion (e.g., second elongate portion 706b of second channel 706) of the second channel. The second elongate portion of the second channel is substantially horizontal. The apparatus further includes a protrusion (e.g., protrusion 726a) coupled to the door panel. The protrusion is positioned with respect to the first elongate portion of the second channel when the door panel is in the first position such that a trailing end portion of the door panel is concurrently lowered and moved laterally with respect to the first elongate portion of the second channel during movement of the door panel from the first position to the second position.

In an embodiment, an apparatus includes a rail (e.g., stationary rail 710a) including a first channel and a second channel. The first channel includes a first end portion (e.g., first elongate portion 702a of the first channel 702) and a second end portion (e.g., second elongate portion 702b of the first channel 702). Each of the first end portion of the first channel and the second end portion of the first channel are substantially linear. The first end portion of the first channel is perpendicular to the second end portion of the first channel. The second channel including a first end portion (e.g., first elongate portion 706a of second channel 706) and a second end portion (e.g., second elongate portion 706b of second channel 706). The first end portion of the second channel and the second end portion of the second channel are each substantially linear. The first end portion of the second channel is diagonal to the second end portion of the second channel. The first end portion of the first channel is non-parallel to the first end portion of the second channel. The second end portion of the first channel is substantially parallel to the second end portion of the second channel. The apparatus further includes a door panel (e.g., door panel 712) coupled to the rail and movable with respect to the rail from a closed position to an open position different from the closed position. The door panel is configured to form a portion of an unmanned aerial vehicle (UAV) landing pad (e.g., landing pad 116) when the door panel is in the closed position. The door panel includes a first protrusion (e.g., protrusion 724a) moveable with respect to the first channel of the rail and a second protrusion (e.g., protrusion 726a) moveable with respect to the second channel of the rail. During movement of the door panel from the closed position towards the open position, the first protrusion is configured to move with respect to the first channel before the second protrusion is moved with respect to the second channel.

In some implementations of the apparatus, the door panel in the closed position is disposed within an opening of the UAV landing pad so that an upper surface of the door panel is substantially co-planar with a surface of the UAV landing pad. The door panel in the open position is lower than the surface of the UAV landing pad and laterally offset with respect to the opening of the UAV landing pad. The opening in the UAV landing pad configured to permit a package to be passed therethrough.

In some implementations of the apparatus, the apparatus further includes an actuator (e.g., motor 722) and a carriage bracket (e.g., carriage bracket 720) operatively coupled between the door panel and the actuator. The carriage bracket is configured to move the door panel with respect to the rail in response to an actuation of the actuator by lowering a first end portion (e.g., protrusion 724a) of the door panel via the first channel towards an outer surface of a package destination repository positioned below the door panel, and laterally sliding the door panel via the first channel and the second channel to expose an access portal of the package destination repository.

In some implementations of the apparatus, the apparatus further includes a cover (e.g., cover 716) operatively coupled to the door panel. The cover has a closed position in which the cover blocks access to an access portal of a package destination repository and an open position in which the cover is laterally offset from the access portal. The cover is configured to be automatically moved from the closed position of the cover to the open position of the cover when the door panel is moved from the closed position of the door panel to the open position of the door panel.

In some implementations of the apparatus, the door panel is substantially co-planar with the surface, or remaining surface, of the UAV landing pad while the door panel is in the closed position.

In some implementations of the apparatus, the first protrusion is shorter in length than the second protrusion such that the first protrusion can be lowered vertically beneath the surface of the UAV landing pad to lower a first side portion of the door panel before the second protrusion is moved with respect to the second channel to lower a second side portion of the door panel opposite the first side portion beneath the surface of the UAV landing pad.

In some implementations of the apparatus, the apparatus further includes a cover (e.g., cover 716) operatively coupled to the door panel. The cover has a closed position in which the cover blocks access to an access portal of a destination repository and an open position in which the cover does not close off the access portal. The apparatus further includes a translating rail (e.g., translating rail 718) movably disposed on the rail. The translating rail is coupled to the door panel and the cover. The translating rail is configured to concurrently move the cover from the closed position to the open position when the door panel is moved from the closed position to the open position.

In some implementations of the apparatus, the UAV landing pad is coupled to and disposed above an access portal of a package destination repository. The access portal is sized and shaped for a package to be passed therethrough.

In an embodiment, a method includes lowering a first side portion of a door panel (e.g., door panel 712) substantially planar with respect to a rail (e.g., stationary rail 710a). The door panel forms a portion of an unmanned aerial vehicle (UAV) landing pad (e.g., landing pad 116) when the door panel is in a closed position before the lowering. The method further includes laterally moving, after the lowering the first side portion, the door panel with respect to the rail and to an open position, a second side portion of the door panel opposite the first side portion of the door panel being lowered with respect to the UAV landing pad subsequent to the lowering of the first side portion of the door panel and during at least a portion of the laterally moving. The method further includes exposing, after the laterally moving, an access portal of a destination repository. The destination repository is coupled to the UAV landing pad. The access portal is sized and shaped for a package to be passed therethrough.

In some implementations of the method, the lowering includes vertically moving a protrusion (e.g., protrusion 724a) coupled to the first side portion of the door panel in a downward direction with respect to a first elongate portion (e.g., first elongate portion 702a of the first channel 702) of a first channel of the rail. The first elongate portion of the first channel is substantially perpendicular to a second elongate portion (e.g., second elongate portion of second channel 702b) of the first channel mutually exclusive from the first elongate portion.

In some implementations of the method, the rail includes a first channel and a second channel. The first channel includes a first elongate portion (e.g., first elongate portion 702a of the first channel 702) and a second elongate portion (e.g., second elongate portion 702b of the first channel 702702b) that is substantially perpendicular to and mutually exclusive from the first elongate portion. The laterally moving includes moving a first protrusion (e.g., protrusion 724a) coupled to the first side portion of the door panel in a lateral direction with respect to the second elongate portion of the first channel. The second channel includes a first elongate portion (e.g., first elongate portion 706a of second channel 706) and a second elongate portion (e.g., second elongate portion 706b of second channel 706). The first elongate portion of the second channel is diagonal to and mutually exclusive from the second elongate portion of the second channel. The laterally moving includes moving a second protrusion (e.g., protrusion 726a) coupled to the second side portion of the door panel diagonally with respect to the first elongate portion of the second channel and then moving the second protrusion laterally with respect to the second elongate portion of the second channel.

In some implementations of the method, the method further includes laterally moving a cover (e.g., cover 716) of the access portal from a closed position to an open position. The laterally moving the cover can be substantially concurrent with the laterally moving the door panel, and automatic (e.g., without human interaction) in response to an actuation of an actuator (e.g., motor 722) operatively coupled to the door panel and the cover.

### Alignment System of a Landing Pad

Some implementations are related to an alignment system of a drone landing pad. In some implementations, an alignment system is coupled to a landing pad (e.g., landing pad 116) and configured to align (e.g., centrally) packages, a drone, and/or a drone landing gear on the landing pad (e.g., to an access portal). In some implementations, the alignment system can be used with a landing pad access door, such as the landing pad access door(s) 700 described at FIGS. 7A-7C, 8, and 9A-9B.

FIG. 10 shows an alignment system 900, according to an embodiment. Alignment system 900 includes bars 901, 903, 905, and 907. Bars 901, 903, 905, 907 can be movably coupled to a landing pad, such as landing pad 116 of FIG. 1. Bars 901, 903, 905, 907 can be moved via one or more actuators. For example, a first actuator can move bar 901, a second actuator can move bar 903, a third actuator can move bar 905, and a fourth actuator can move bar 907. Bars 901 and 905 can be substantially parallel with each other, and substantially perpendicular with bars 903 and 907.

Bars 901 and 905 can each move in a first direction and second direction (but not a third and fourth direction), the first and second directions being substantially opposite. Bars 903 and 907 can move in the third and fourth direction (but not the first and second direction), the third and fourth direction being substantially opposite. Arrow A1 in FIG. 10 is an example of the first direction and the second direction, and arrow A2 in FIG. 10 is an example of the third direction and the fourth direction. Bars 901 and 905 can be located above (e.g., at a non-zero distance) bars 903 and 907.

Bars 901, 903, 907, and/or 909 can move in the first, second, third, and/or fourth direction to modify a position (e.g., location and/or orientation) of a package, drone, drone landing gear, and/or the like on the landing pad. Bars 901, 903, 905, 907 can be used during the overall process to drop off a package (e.g., place package in container 100) and/or have a package picked up (e.g., by a drone on landing pad 116). For example, after a package has been dropped off by a drone in an interior region defined by bars 901, 903, 905, 907 and does not include opening 909, bars 901, 903, 905, and/or 907 can move close to opening 909 to decrease the size of the interior region and place (e.g., locate and/or orient) that package at opening 909. As another example, after a package within a package repository of container 100 has been placed on landing pad 116 with elevator 120, shelf 118, and a polar-axial robot, bars 901, 903, 905, 907 can be used to move the package to a predetermined location (and/or orientation) on landing pad 116 for pickup by a drone.

In some implementations, one or more of bars 901, 903, 905, 907, after moving from the first or original position to a second or new position to move package closer to opening 909, move to or return to its respective first original position or to a third position between the first position bar and the second position of the bar (e.g., after the package is moved through opening 909, before the package is moved through opening 909, or while the package is moving through opening 909). In some implementations, for example, one or more of bars 901, 903, 905, 907 automatically moves or returns from the second position to the first position of the bar (or towards the first position to a third position of the bar) before the package is moved through the opening 909 or access portal.

Bars 901, 903, 905, 907 can move in any sequence/timing. For example, bars 901 and 905 can move first, and bars 903 and 907 can move second after bars 901 and 905 have stopped moving. As another example, bar 901 can move first, bar 903 can move after bar 901 has stopped moving, bar 905 can move after bar 903 has stopped moving, and bar 907 can move after bar 905 has stopped moving. As another example, bars 901, 903, 905, 907 can all move at different times, all at the same time, or a combination of some bars moving at different times and some bars moving at the same time.

In some implementations, a package is raised to the surface of a landing pad before the drone arrives. The package is then positioned with respect to the landing pad by alignment system 900 using bars 901, 903, 905, and 907. The package can optionally then be lowered (e.g., via an elevator, such as elevator 120) from the landing pad, for example to permit a drone and/or a landing gear of a drone to land or otherwise be disposed on the landing pad. In such implementations, the package can then be raised to the surface of the landing pad after the drone/drone landing gear lands and/or is positioned with respect to the landing pad. In some implementations, the positioning of the package by alignment system 900 causes the package to be raised into an interior area defined by the drone landing gear.

In some implementations, the receiver and/or transceiver included in the container (e.g., container 100) can receive an indication (e.g., electronic signal) that a drone is approaching, the drone has arrived, a package has been dropped off at landing pad 116, and/or like, and the processor operatively coupled to the memory and the receiver and/or transceiver can send a signal (e.g., electronic signal) to the actuator(s) coupled to bars 901, 903, 905, 907 to cause bars 901 903. 905, 907 to move the package towards opening 909 in response.

For a package received from a drone, alignment system 900 can position the received package (e.g., after release by the drone) to be placed more accurately on the elevator (or shelf thereof) so that the package can be brought inside the container 100, and more particularly so that the package is in a known, predetermined position with respect to the shelf of the elevator when the package is brought inside of the container. This enables an internal transfer system (e.g., polar-axial robot described in more detail herein) to pick up the package more accurately for internal transfer within the container. For pickup of a package by a drone, alignment system 900 can position the package (relative to opening 909) at a predetermined location that can, for example, be known by the drone picking up the package. More particularly, the alignment system 900 can first position the package relative to the opening 909, lower the package into the container, align the drone via its landing gear relative to the opening 909, and then raise the package to the landing pad such that the package is at the predetermined position with respect to the landing pad, and thus also with respect to the drone, to enable more accurate pick-up of the package by the drone. If the package is not a location already known by the drone, or the drone has to determine where the package is before picking the package up, the drone may take longer and/or use additional sensors to determine where and/or how to pick the package up.

Although not explicitly shown in FIG. 10, alignment system 900 can include one or more controllers for controlling functions of alignment system 900. For example, the controllers can control one or more actuators to cause bars 901, 903, 905, and/or 907 to move towards and/or away from opening 909.

In some implementations, each of the one or more controllers can include a processor and a memory operatively coupled to the processor. The processor can be, for example, a hardware based integrated circuit (IC), or any other suitable processing device configured to run and/or execute a set of instructions or code. For example, the processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor can be configured to run any of the methods and/or portions of methods discussed. The memory can be, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory can include extendable storage units that can be added and used incrementally. In some implementations, the memory can be a portable memory (e.g., a flash drive, a portable hard disk, and/or the like) that can be operatively coupled to the processor. In some instances, a memory can be remotely operatively coupled with a compute device (not shown).

In some implementations, the memory includes a representation of instructions (e.g., code) that can be used to control the alignment system 900. In some implementations, the instruction can include code to cause, via the processor, one or more actuators to move at one or more times for certain periods of time in one or more sequences to carry out the techniques described herein. For example, the instructions can include code to cause the processor to send a first electronic signal to a first actuator that can control a first bar (e.g., bar 901), cause the processor to send a second electronic signal to a second actuator that can control a second bar (e.g., bar 903), cause the processor to send a third electronic signal to a third actuator that can control a third bar (e.g., bar 905), and cause the processor to send a fourth electronic signal to a fourth actuator that can control a fourth bar (e.g., bar 907).

In an embodiment, a method includes moving, during a first time period and via an actuator mechanically coupled to a plurality of elongate bars disposed above and movably coupled to a landing pad for a drone, a first elongate bar (e.g., bar 901) from the plurality of elongate bars laterally from a first position to a second position. The method further includes moving during the first time period and concurrently with the moving the first elongate bar, via the actuator, a second elongate bar (e.g., bar 903) from the plurality of elongate bars from a first position to a second position. The second elongate bar has an elongate axis substantially transverse to an elongate axis of the first elongate bar. The method further includes moving, during a second time period subsequent the first time period and via the actuator, a third elongate bar (e.g., bar 905) from the plurality of elongate bars from a first position to a second position. The third elongate bar has an elongate axis substantially parallel to the first elongate bar. The method further includes moving, during a third time period and subsequent the first time period and independently of the moving the third elongate bar, a fourth elongate bar (e.g., bar 907) from the plurality of elongate bars from a first position to a second position. The fourth elongate bar has an elongate axis substantially parallel to the second elongate bar. The first elongate bar, the second elongate bar, the third elongate bar and the fourth elongate bar collectively define a perimeter of an interior region. The interior region has a first area when each of the first elongate bar, the second elongate bar, the third elongate bar and the fourth elongate bar are in their respective first positions. The interior region has a second area when each of the first elongate bar, the second elongate bar, the third elongate bar and the fourth elongate bar are in their respective second positions. The second area is less than the first area. The moving the first elongate bar, the moving the second elongate bar, the moving the third elongate bar and the moving the fourth elongate bar collectively align at least one of a package or the drone via landing gear of the drone coupled to the drone or a landing gear of the drone, with respect to an access portal (e.g., opening 909) defined by the landing pad so that the package or the drone is positioned above the access portal and in a predetermined orientation with respect to the access portal.

In some implementations of the method, the second elongate bar and the fourth elongate bar are substantially perpendicular to the first elongate bar and the third elongate bar. The perimeter of the interior region is continuous.

In some implementations of the method, the method further includes receiving, at a processor coupled to the actuator, a signal (e.g., electronic signal) that indicates the at least one of the package or the landing gear has landed on a surface of the landing pad. The moving the first elongate bar, the moving the second elongate bar, the moving the third elongate bar and the moving the fourth elongate bar each are automatic (e.g., without human interaction) in response to the receiving.

In some implementations of the method, the method further includes receiving the package and the landing gear on a surface of the landing pad. The package is at least partially positioned within an interior region defined by the landing gear when the package and the landing gear are received on the surface of the landing pad.

In some implementations of the method, the moving the first elongate bar and the moving the second elongate bar ceases before the moving the third elongate bar.

In some implementations of the method, a start time of the third time period is subsequent to a start time of the second time period and the third time period at least partially overlaps with the second time period so that the moving the fourth elongate bar partially overlaps in time with the moving the third elongate bar.

In some implementations of the method, the method further includes opening an access door (e.g., door 712) associated with the access portal after the moving the fourth elongate bar.

In some implementations of the method, the method further includes returning, after the moving the fourth elongate bar, each of the first elongate bar, the second elongate bar, the third elongate bar, and the fourth elongate bar to (1) one of the respective first position of each of the first elongate bar, the second elongate bar, the third elongate bar, and the fourth elongate bar, respectively, or (2) a third position between the first position and the second position. The returning is performed before the package is transferred through the access portal.

In some implementations of the method, the first elongate bar is movably coupled to the landing pad such that the first elongate bar is positioned above at least a first portion of the second elongate bar and at least a first portion of the fourth elongate bar. The third elongate bar is movably coupled to the landing pad such that the third elongate bar is positioned above at least a second portion of the second elongate bar and at least a second portion of the fourth elongate bar.

In an embodiment, a method includes positioning a package (e.g., package 913) for pickup by a drone at a predefined position and a predetermined orientation with respect to a landing pad (e.g., landing pad 116) of a repository. The positioning includes moving, at a first time and via an actuator coupled to a landing pad for a drone, a first pair of elongate bars (e.g., bars 901 and 903) with respect to the landing pad and towards an access portal defined by the landing pad. The first pair of elongate bars include a first elongate bar that moves in a first direction during the moving and a second elongate bar that moves in a second direction substantially transverse to the first direction during the moving. The positioning further includes moving, at a second time and via the actuator, a second pair of elongate bars (e.g., bars 905 and 907) with respect to the landing pad and towards the access portal. The second pair of elongate bars include a third elongate bar that moves in a third direction during the moving the second pair of elongate bars. The third direction is substantially opposite the first direction and substantially transverse to the second direction. The second pair of elongate bars includes a fourth elongate bar that moves in a fourth direction during the moving the second pair of elongate bars. The fourth direction is substantially opposite the second direction and substantially transverse to the first direction. The second time is after the first time. The method further includes moving at a third time and via the actuator each of the first elongate bar, the second elongate bar, the third elongate bar and the fourth elongate bar away from the access portal. The third time after the second time. The method further includes positioning a landing gear of the drone at a second predefined position and in a second predetermined orientation with respect to the landing pad. The positioning the landing gear includes moving, at a fourth time and via the actuator, the first pair of elongate bars with respect to the landing pad and towards the access portal. The first elongate bar from the first pair of elongate bars moves in the first direction during the moving and the second elongate bar from the first pair of elongate bars moves in the second direction during the moving at the fourth time. The positioning the landing gear includes moving, after the fourth time and via the actuator, the third elongate bar in the third direction with respect to the landing pad and towards the access portal. The positioning the landing gear includes moving, after the fourth time and via the actuator, the fourth elongate bar in the fourth direction with respect to the landing pad and towards the access portal, a start time of the moving the fourth elongate bar is subsequent to a start time of the moving the third elongate bar.

In some implementations of the method, the method further includes receiving, at a processor operably coupled to the actuator, a signal that indicates a drone is approaching the landing pad to pick up the package.

In some implementations of the method, the method further includes elevating the package, before the positioning the package, through the access portal and from within the repository, to a position in which a lower surface of the package is substantially co-planar with an upper surface of the landing pad.

In some implementations of the method, the method further includes lowering the package into the repository after the positioning the package and before the positioning the landing gear.

In some implementations of the method, the method further includes elevating the package, after the positioning the landing gear, through the access portal and from within the repository, to a position in which the package is at least partially received within an interior region defined by the landing gear.

In some implementations of the method, the method further includes receiving a signal indicating an outgoing delivery of a package for pickup by the drone. The method further includes elevating, in response to the receiving and before the positioning the package, the package from the repository and through the access portal.

In some implementations of the method, the moving any one of the first elongate bar, the second elongate bar, the third elongate bar or the fourth elongate bar includes translating the first elongate bar, the second elongate bar, the third elongate bar or the fourth elongate bar with respect to the landing pad.

In an embodiment, a non-transitory, processor-readable medium stores code representing instructions to cause a processor to move a package (e.g., package 913) through an access portal (e.g. opening 909) defined by a landing pad (e.g., landing pad 116) for a drone and from within a repository coupled to the landing pad, to a position in which a lower surface of the package is substantially planar with an upper surface of the landing pad. The code further includes instructions to cause the processor to translate, at a first time and via an actuator mechanically coupled to a plurality of elongate bars coupled to the landing pad and positioned laterally away from the access portal, a first pair of elongate bars (e.g., bars 901 and 903) from the plurality of elongate bars laterally towards the access portal. The first elongate bar from the first pair of elongate bars has an elongate axis substantially transverse to an elongate axis of a second elongate bar from the first pair of elongate bars. The code further includes instructions to cause the processor to translate, at a second time subsequent the first time and via the actuator, a second pair of elongate bars (e.g., bars 905 and 907) from the plurality of elongate bars laterally towards the access portal. A first elongate bar from the second pair of elongate bars has an elongate axis substantially transverse to an elongate axis of a second elongate bar from the second pair of elongate bars. The plurality of elongate bars collectively moves, when the first pair of elongate bars are translated at the first time and the second pair of elongate bars are translated at the second time, the package into a first predefined position and a first predetermined orientation with respect to the landing pad. The code further includes instructions to cause the processor to move, at a third time subsequent the second time and via the actuator, the first pair of elongate bars and the second pair of elongate bars laterally away from the access portal and the package to permit a landing gear of the drone to land on the surface of the landing pad. The code further includes instructions to cause the processor to translate, at a fourth time subsequent the third time and via the actuator, the first pair of bars laterally towards the access portal and the landing gear. The code further includes instructions to cause the processor to translate, subsequent the fourth time and via the actuator, the second pair of elongate bars laterally towards the access portal and the landing gear. The plurality of elongate bars collectively moves, when the first pair of elongate bars are translated at the fourth time and the second pair of elongate bars are translated subsequent the fourth time, the landing gear into a second predefined position and a second predetermined orientation with respect to the landing pad so that the landing gear is positioned to receive the package for pickup by the drone.

In some implementations of the non-transitory, processor-readable medium, the first elongate bar from the first pair of elongate bars is disposed over a portion of the second bar from the first pair of elongate bars. The first elongate bar from the second pair of elongate bars is disposed over a portion of the second bar from the second pair of elongate bars. The first elongate bar from the first pair of elongate bars is substantially parallel to the first elongate bar from the second pair of elongate bars. The second elongate bar from the first pair of elongate bars is substantially parallel to the second elongate bar from the second pair of elongate bars.

In some implementations of the non-transitory, processor-readable medium, the code representing instructions to cause the processor to translate subsequent the fourth time includes code representing instructions to cause the processor to initiate translation of the first elongate bar from the second pair of elongate bars before translation of the second elongate bar from the second pair of elongate bars is initiated.

In some implementations of the non-transitory, processor-readable medium, the code further comprises code representing instructions to cause the processor to receive a signal that indicates an outgoing delivery of the package for pickup by the drone. The code further comprises code representing instructions to cause the processor to elevate a shelf on which the package is disposed, in response to receipt of the signal, to elevate the package from within the repository through the access portal to a position in which a surface of the shelf is substantially co-planar with the surface of the landing pad.

FIG. 11 shows a perspective view of an exterior of a container, according to an embodiment. FIG. 11 shows container 1100, landing pad 1102, drone 1104, package 1106, door 1008, portal 1110, roof 1112 and an overhang 1114. The container 1100 (e.g., which can be similar or identical to container 100) includes landing pad 1102 (e.g., which can be similar or identical to landing pad 116 or any other landing pad described herein) that can be used for accepting a package (e.g., package 1106) from and/or providing a package to a drone, such as drone 1104. The landing pad 1102 can include a landing pad access door (e.g., landing pad access door 700 such as that described herein with respect to FIGS. 7A-7C, 8, and 9A-9B) so that the package 1106 can be moved into and/or out of container 1100. The landing pad 1102 can also include an alignment system (e.g., alignment system 900 described herein) to align the package 1106 and/or drone landing gear and thereby the drone on landing pad 1102. The landing pad 1102 can be disposed on the roof 112 of the container. The container 1100 can also include the portal 1110, which can be configured to receive packages from and/or provide packages to a user. The portal 1110 can include and/or be coupled to a PAS receptacle (e.g., receptacle 500). The overhand 114 can be located above the portal 1110, to help protect the user, portal 1110, and/or a user interface thereunder from, for example, sun, rain, snow, or hail. The door 1108 can be used for appropriate personnel (e.g., maintenance technicians or the like) to enter the container 1100. The door 1108 can be operable, for example, using a key, fingerprint reader, and/or the like.

Note that some of the implementations described above were in the context of a drone. In other implementations, the unmanned vehicle can be a different type of unmanned vehicle, such as an aerial vehicle different than a drone, a ground vehicle, or a water vehicle. Packages can be dropped off at or picked up from the destination box using any acceptable means, such as the unmanned vehicle entering into the destination box (e.g., via a door in the destination box configured to open when the unmanned vehicle approaches) to drop off or pick up a package, aligning the packages and/or unmanned vehicle at or within the destination box, a robot arm of the destination box retrieving the package from or providing the package to the unmanned vehicle, a robot arm of the unmanned vehicle dropping the package off at or retrieving the package from a shaft of an elevator, manually by a person, and/or the like. Accordingly, in some variations, the shaft and elevator can move in any direction in addition to or instead of vertically, such as horizontally or diagonally. Also, in some variations, the portal by which packages are dropped off or picked up by the unmanned vehicle can be anywhere at the destination box, such as beneath, to the side of, above, and/or the like. Also, in some variations, the destination box can have different portals for different types of unmanned vehicles, such as a first portal for drone package pickup or dropoff at the top surface of the destination box and a second portal for ground vehicle or water vehicle package pickup or dropoff inside or at the side of the destination box. In some variations, where the unmanned vehicle is a water vehicle, the destination box can float on the water (e.g., a “floating dock” or partially on land and partially in water so that a user can pick up or drop off a package on the land and the water vehicle can pick up or drop off a package in the water.

Note that some of the implementations described herein are in the context of a package being transferred between an unmanned vehicle (e.g., a drone) and a user/human. In other implementations, however, a package can be transferred between any number of any type of devices and/or users/persons. For example, a first unmanned vehicle can drop off a package at a container for storage until a second unmanned vehicle arrives to pick the package up. As another example, a first person can drop off a package at container for storage until a second person arrives to pick the package up.

All combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments and unless stated otherwise, the terms “about” “substantially” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

What is claimed is:

1. An apparatus, comprising:
a container at least partially disposed in a package repository having access to an unmanned vehicle portal, the container defining a chamber configured to receive a package therein from a user;
a first actuatable wall portion movably coupled to a first side of the container, the first actuatable wall portion configured to move in a first direction into the chamber when the first actuatable wall portion is actuated;
a second actuatable wall portion movably coupled to a second side of the container, the second actuatable wall portion configured to move in a second direction, different from the first direction, into the chamber when the second actuatable wall portion is actuated;
the first actuatable wall portion and the second actuatable wall portion being collectively configured to move, when the first actuatable wall portion is moved in the first direction and the second actuatable wall portion is moved in the second direction, the package received in the chamber into a predetermined position with respect to the container.

2. The apparatus of claim 1, wherein the predetermined position includes a location with respect to the chamber and an orientation with respect to the chamber.

3. The apparatus of claim 1, wherein the first side of the container is substantially opposite the second side of the container, the first actuatable wall portion configured to move towards the second actuatable wall portion when the first actuatable wall portion is moved in the first direction, the second actuatable wall portion configured to move towards the second first actuatable wall portion when the second actuatable wall portion is moved in the second direction.

4. The apparatus of claim 1, further comprising:
an actuator coupled to the container and disposed external to the chamber; and
an elongate member coupled between the actuator and the first actuatable wall portion and disposed external to the chamber, the actuator configured to move the elongate member in a direction away from a vertical centerline of the chamber causing the elongate member to move the first actuatable wall portion in the first direction and towards the vertical centerline of the chamber.

5. The apparatus of claim 1, wherein the container includes a top, a bottom, a first sidewall and a second sidewall,
the first side of the container including the first sidewall of the container,
the second side of the container including the second sidewall of the container,
the first actuatable wall portion extended through the first sidewall, and
the second actuatable wall portion extended through the second sidewall.

6. The apparatus of claim 1, further comprising:
a platform at least partially disposed within the chamber, the platform coupled to and disposed spaced apart a non-zero distance from a bottom of the container, the platform having a surface configured for the package to be disposed thereon.

7. The apparatus of claim 1, further comprising:
a platform disposed within the chamber such that the platform is spaced apart a non-zero distance from a bottom of the container, the platform having a surface configured for the package to be disposed thereon;
a force sensor coupled to the platform, the force sensor configured to measure a mass of the package disposed on the platform; and
a processor operably coupled to the sensor, the processor configured to automatically determine a first position of the package with respect to the platform when the package is disposed on the platform based on information received from the sensor, the processor configured to automatically selectively actuate each of the first actuatable wall portion and the second actuatable wall portion based on the determined first position to move the package to the predetermined position.

8. The apparatus of claim 1, further comprising:
a third actuatable wall portion movably coupled to a third side of the container between the first side of the container and the second side of the container, the third actuatable wall portion configured to move in a third direction that is substantially perpendicular to the first direction, into the chamber when the third actuatable wall portion is actuated,
the first actuatable wall portion, the second actuatable wall portion and the third actuatable wall portion being collectively configured to move, when (1) the first actuatable wall portion is moved in the first direction, (2) the second actuatable wall portion is moved in the second direction, and (3) the third actuatable wall portion is moved in the third direction, the package received in the chamber into the predetermined position with respect to the container.

9. The apparatus of claim 1, further comprising:
a third actuatable wall portion movably coupled to a third side of the container between the first side of the container and the second side of the container, the third actuatable wall portion configured to move in a third direction into the chamber when the third actuatable wall portion is actuated, the third actuatable wall portion forming a rear wall of the chamber opposite a port through which the package is insertable into the chamber.

10. The apparatus of claim 1, wherein the second actuatable wall portion forms a rear wall of the chamber opposite a port through which the package is insertable into the chamber, the second actuatable wall portion configured to be automatically movably displaced for the package to be retrieved from the chamber and moved into the package repository by an automated robotic arm of the package repository.

11. An apparatus, comprising:
a container at least partially disposed in a package repository having access to an unmanned vehicle portal, the container defining a chamber configured to receive a package therein;
a platform disposed within the chamber such that the platform is spaced apart a non-zero distance from a bottom of the container, the platform having a surface configured for the package to be disposed thereon;
a sensor coupled to the platform, the sensor configured to measure force or weight data associated with the package being disposed on the platform; and
a processor configured to receive, from the sensor, a signal associated with the force or weight data associated with the package, the processor configured to automatically calculate a center of mass of the package based on the signal.

12. The apparatus of claim 11, wherein the sensor is configured to measure force or weight data associated with the package being disposed on the platform in a first position, the apparatus further comprising:
an actuator operably coupled to the processor and coupled to the container,
the processor is configured to send a signal to the actuator to move the package to a second position in which the center of mass of the package is disposed substantially at a predetermined position on the surface of the platform.

13. The apparatus of claim 11, wherein the sensor includes at least three load cells, the platform is mounted on the at least three load cells.

14. The apparatus of claim 11, wherein the container includes a movable wall defining a rear side of the chamber opposite a port through which the package is insertable into the chamber, the movable wall configured to be movably displaced for retrieval of the package from the chamber by an automated robotic arm of the package repository.

15. The apparatus of claim 11, wherein the container includes an actuatable wall portion that forms a portion of at least one of a sidewall or a rear wall of the chamber, the actuatable wall portion is configured to move the package within the chamber and on the platform to a second position with respect to the surface of the platform, and
the processor is configured to calculate the center of mass of the package in the second position based on an updated signal from the sensor.

16. The apparatus of claim 11, further comprising:
a plurality of actuatable wall portions that form at least a portion of the chamber, the plurality of actuatable wall portions being selectively actuatable in response to the processor's calculation of the center of mass of the package with respect to the surface of the platform to contact the package and adjust the position of the center of mass of the package with respect to the surface of the platform.

17. A method, comprising:
receiving, from a plurality of sensors, a plurality of signals associated with a mass of a package received in a first position on a platform in a container coupled to a package repository and having access to an unmanned vehicle portal;
calculating a center of mass of the package with respect to the platform;
actuating, in response to the calculating, a first actuatable wall portion to move the package in a first direction with respect to the platform;
actuating, in response to the calculating, a second actuatable wall portion to move the package in a second direction with respect to the platform;
the actuating the first actuatable wall portion and the actuating the second actuatable wall portion collectively move the package towards a second position on the platform to locate the center of mass of the package at a predetermined position with respect to the platform.

18. The method of claim 17, wherein:
the first actuatable wall portion forms at least a portion of a rear wall of the container, and
the second actuatable wall portion forms at least a portion of a sidewall of the container, the rear wall being substantially perpendicular to the side wall.

19. The method of claim 17, further comprising:
determining a mass of the package when the package is received on the platform; and
providing an indication that the package is not acceptable when at least one of (1) the package exceeds a predetermined mass, or (2) the package cannot be moved with respect to the platform so that so that the center of mass of the package is located at the predetermined position with respect to the platform.

20. The method of claim 17, wherein the first actuatable wall portion forms at least a portion of a rear wall of the container, the method further comprising:
moving, after the actuating the first actuatable wall portion and after the actuating the second actuatable wall portion, the first actuatable wall portion with respect to the container to produce a port through which the package is movable from the container and to one of the package repository or the unmanned vehicle portal, only when (1) actuation of each of the first actuatable wall portion and the second actuatable wall portion collectively moved the package to the second position on the platform to locate the center of mass of the package at the predetermined position with respect to the platform, and (2) a mass of the package does not exceed a predetermined threshold.
